(19) United States
(12) Patent Application Publication
(10) Pub. No.: US 2011/0233236 A1
(43) Pub. Date: Sep. 29, 2011

(54) Continuous, complete, automatic, non-leaking, non-aerating, positive pressure one-piece vent and pouring combination utilizing one direct venting aperture

(76) Inventors: Craig E. Brown, Mount Zion, IL (US); Robert J. Brown, Chesterfield, MO (US)

(21) Appl. No.: 13/065,411

(22) Filed: Mar. 22, 2011

Related U.S. Application Data
(60) Provisional application No. 61/340,993, filed on Mar. 25, 2010.

(51) Int. Cl. B67D 3/00

(52) U.S. Cl. 222/481; 222/478; 222/481.5

(57) ABSTRACT

A vent prevents a vacuum within an inverted container of liquid and eliminates components found in other container vents. The vent utilizes a conical or other shaped venting tube extending from the closure or a reservoir with reservoir extension and an air conduit extending inferiorly from a closure. The closure is either a leak resistant or leak proof seal. The superior aspect of the reservoir contains an inferiorly projecting air conduit, opening at the volumetric center of the reservoir. The reservoir extension projects distally into the container to reach the inferior aspect of the container. The vent provides an airway between the outside and the interior of the container so air freely passes to the distal aspect of the container without contaminating the liquid. Any liquid within the reservoir extension then collects in the reservoir during inversion of the container and then returns to the container when upright. Various attachments may be associated with the container, such as a nipple or spoon for infant feeding.

### CROSS REFERENCE TO RELATED APPLICATION

This non provisional application claims priority to the application No. 61/340,993, filed Mar. 25, 2010, which claims priority to the to the pending non-provisional application Ser. No. 12/321,455 which was filed on Jan. 21, 2009 and which claims priority to the provisional application 61/062,754 which was filed on Jan. 29, 2008, which claims priority to the pending non-provisional application Ser. No. 12/321,439 which was filed on Jan. 21, 2009 and which claims priority to the provisional application 61/062,817 which was filed on Jan. 29, 2008, to the pending PCT application Serial No. US2009/000133 which was filed on Jan. 9, 2009 designating the U.S., which claims priority to the pending non-provisional application Ser. No. 12/291,749 which was filed on Nov. 18, 2008, which claims priority to the provisional application 61/003,635 which was filed on Nov. 19, 2007, to the pending non-provisional application ser. No. 12/072,465 which was filed on Feb. 26, 2008, which claims priority to the pending non-provisional application Ser. No. 12/002,468 which was filed on Dec. 17, 2007, which claims priority to the abandoned non-provisional patent application Ser. No. 11/258,966 which was filed on Oct. 25, 2005, which claims priority to the pending PCT application Serial No. US2006/022866 which was filed on Jun. 13, 2006 designating the U.S. which claims priority to the abandoned non-provisional patent application Ser. No. 11/152,320 which was filed on Jun. 14, 2005, which claims priority to the now patented design patent application Ser. No. 29/226,482 which was filed on Mar. 29, 2005, which claims priority to the non-provisional patent application having Ser. No. 10/283,878, which was filed on Oct. 30, 2002, which was filed during the pendency of PCT application Serial No. US2001/014,365 which was filed on May 4, 2001 designating the U.S., and which claimed priority to U.S. provisional application Ser. No. 60/202,851 filed on May 8, 2000.

### FIELD OF THE INVENTION

This invention relates to a range of proportions for a vent and a pouring aperture working in combination to fully vent a container in a fashion that is complete, continuous, non-leaking, and without aerating and contaminating the liquid. Additionally, the vent provides a positive pressure in the container to assist in promoting release of the liquid on demand. This invention further describes a vent for containers to prevent contamination of liquid in the container. More particularly, this invention relates to a vent that prevents the creation of a vacuum inside the container, including containers for liquor, wine, sports drinks, rehydration drinks, water and cola, and other liquids. The invention prevents introduction of air into the liquid when poured, thus preventing oxidation and other untoward reactions with the liquid of the container, which alter the taste and quality of the liquid in the container when dispensed.

### BACKGROUND OF THE INVENTION

The bottom, or distal, end of containers, particularly liquor, and wine, and other liquid containers is moved upwardly to pour liquid from the bottle, or container, and a vacuum forms during the pour. Air enters the container to fill the vacuum so that more liquid may pour from the container. The air that enters a conventional container in the pouring position is lighter than the liquid in the container and thus, seeks and travels to the most superior portion of the container, that is, its highest point, or its inverted bottom in this pouring position, which is the distal aspect of the container. In traveling to the distal portion of the container, the air contaminates the liquid as it mixes with it, and precipitates chemical reactions within the liquid. Any air that also mixes into the liquid is another untoward outcome of pouring that occurs from prior art containers.

Many liquids require precise ingredients, and these ingredients are manufactured or grown under strictly controlled conditions. The combining of these ingredients also undergoes close monitoring in a controlled environment, as does the handling of the ingredients and the product in every stage of manufacturing. Also, the handling of the final product has similar tight controls for optimization. Liquors, wines, and other beverages serve as prime examples of the precision and excellence found in a particular industry. The growers of the ingredients of many types of liquor, particularly wine, and the processors of liquors and other liquids, take many precautions to ensure the maximal quality during every step of the production process. But, oxidation of many of the ingredients of wine may occur and diminish the quality of the wine, possibly to the point of consumer rejection. Other unfavorable chemical reactions occur due to the introduction of air into other conventional containers of liquid, such as cola, including the introduction of other airborne chemicals, pollutants, particulates, and the like that may co-contaminate the liquid. Unfortunately, these unfavorable reactions occur repeatedly to the remaining liquid in a conventional container with each pour. The undesirable effects increase many times over as air is frequently reintroduced, with continuing contamination of the liquid. Manufacturers of other liquids have similar and significant need to prevent the contamination of liquids by air.

### DESCRIPTION OF THE PRIOR ART

Prior art containers that hold and pour liquids and have disadvantages such as leaking, introducing air into the liquid, not pouring on demand, not venting the container, not providing a positive pressure inside the container, and utilizing more than one component to the vent. Some containers utilize a vent, including liquor bottles and other liquid containers. Frequently, however, such prior art vents require an orientation of the vent, in an upward position, such as U.S. Pat. No. 3,168,221 to Parker. If the vent is not oriented correctly, a significant amount of liquid is spilled from the vent to the outside of the container and typically onto the user of the container. Prior art containers may leak because of container or container component compression in any container direction. Containers may increasingly leak from an increasing amount of pressure on the container or its components and increasing dispenser size. Leaks often take place with the prior art container's reservoir being in an inverted position. Leaks also appear when the neck size increases.

One prior art vent terminates at the wall of the reservoir, which requires an orientation of the container to prevent leakage. Another prior art container, when in the dispensing position with a portion of the vent tube directed toward the bottom of the container and submersed in the liquid, introduces air into the liquid and only limited venting takes place, and only after a vacuum has formed. Many prior art containers introduce a multitude of air bubbles into the liquid in the container. Prior art containers also suffer a prolonged lack of venting due to the capillary action of a small vent tube and may trigger a partial vacuum. Further, over tightening of a collar upon an existing container leads to a complete vacuum. Also, prior art containers may trigger the occurrence of negative pressure in the container. Some of the prior art containers utilize a check valve to slow or prevent liquid from leaking from the container, but a negative pressure must form in the container in order for the valve to open, which introduces other negative effects. Prior art containers also prevent the beneficial effect of formation of positive pressure formation in the container.

During pouring from a prior art container, the path of the liquid stream frequently becomes erratic, thereby making measurement of the liquid dispensed difficult. Prior art containers, especially those of glass, are more difficult to manufacture. Other prior art containers require drilling a hole into the neck of a narrow-neck container as a separate operation. Some other prior art containers attach their reservoirs to the container, utilizing a needle nose pliers, grasping the short vent tube and inserting it into the hole in the neck of the container. Sometimes a ring is attached to the reservoir in order to center the reservoir. However, a reservoir with an attached ring becomes impossible to insert into any size container because the ring centers the reservoir in the center of the neck, preventing insertion of the small vent tube into the neck of the container. If the ring is omitted, the above venting mechanism only has support from the small vent tube in the neck of the container. Tightening the closure too tightly on many prior art containers seals the vent closed, making it inoperable. Further, improper sealing at the closure then may lead to leakage outside the container. A fair number of prior art containers cannot be completely disassembled, which prevents cleaning and results in bacterial buildup and residue, and therefore prevents reuse. Prior art containers also take few steps to prevent the problems associated with air blending with the liquids in the containers Alas, prior art containers alter the quality of liquid product contained therein as air enters the liquid. Each usage of a prior art container brings in a volume of air that leads to oxidation and other contamination of liquid. Usage and air entrainment lead to the chemical reactions that change the liquid regarding smell, color, taste, and air content among other things. These changes may accumulate and adversely affect the value of the liquid, leading ultimately to its removal from store shelves.

During pouring from prior art containers, liquid within the venting tube may frequently leak from the container. Liquid also lags and remains in the venting tube, that is, slowly evacuates from the venting tube and returns to the container during inversion and usage of the container. In using prior art containers, the users often do not have the desired rate of pouring of liquid out of the container and also do not have an even rate of pouring of liquid. Prior art containers with vents exhibit a hesitancy of initial liquid flow as the liquid pours from the container upon inversion. Also, the reservoir extension, avoids seeking the distal and lateral aspect of the container, which may lead to contact of the liquid with air, thus degrading the liquid in the container.

Also, one version of a prior art vent U.S. Pat. No. 3,168,221 to Parker, which is slightly smaller than the pouring spout, is cylindrical and extends from the outside of the container to the bottom of the container, and leaks a significant amount of fluid from the vent when poured, due to the lack of a significant air pressure stream in the vent to propel the liquid in the air vent back into the container before it leaks to the exterior of the container. In another version of the vent to Parker, the vent is much smaller in relation to the liquid pouring spout and liquid either pours slower than desired from the liquid spout or won't pour at all due to lack of venting relative to the rate of liquid being poured. Also, in the patent to Parker, as well as those to others, the vent doesn't extend to the bottom of the container, which minimizes the venting of the container, as liquid overlying the exit of the vent prohibits air entry into the vent and container, until a sufficient detrimental vacuum has formed in the container. In all of the versions of the patent to Parker, contamination of the liquid by the air entering the container occurs, and no desirable positive pressure is present in the container at the onset of pouring.

Some current containers utilize no venting at all into the container and attempt to vent through the drinking aperture of the container while the user is drinking the liquid. If a large aperture at the top of the container is used to drink from, in order to mimic a cup, spilling easily occurs, especially with children and anyone engaging in any type of movement while attempting to drink. Some containers have resorted to a smaller aperture in the container, which also introduces multiple disadvantages. The primary disadvantage to that arrangement is that air must enter the container through the liquid as the liquid exits, which aerates the liquid exiting the container as well as the liquid remaining in the container. Aeration has multiple significant disadvantages, as is outlined. Another disadvantage of a small drinking aperture in an unvented container is that a vacuum is present in the container, which slows liquid flow and doesn't allow for control of removing the liquid.

### SUMMARY OF THE INVENTION

Liquid occupies a container, preferably closed at its aperture to prevent spillage, unless opened for pouring. The closure of the container may be of any type, either locating on the interior of the aperture of the container or on the exterior of the container over the aperture. Both closures locations typically provide a spill-resistant or spill-proof closure.

The first aperture conducts liquid and typically has two ends: proximal and distal. The proximal end typically extends to the superior and lateral surface of the closure and may be of any configuration to assist in pouring the liquid from the container. The distal end of the liquid aperture typically ends at the distal end of the closure. Any portion of this aperture may contain a hollow conduit for optimization of the direction and amount of the fluid flow. A liquid conduit may be inserted into the liquid aperture of the closure at any time during preparation or usage of the container to assist in pouring. A liquid conduit may also come already attached to the closure to assist in pouring. The liquid conduit may be fixed or adjustable in its configuration. The second aperture contains an air aperture vent.

The preferred embodiment of this invention consists of only one additional part, a reservoir and its extension, which is attached to a container and its closure. The invention may consist of the reservoir with its extension; the closure and the reservoir with its extension; or, alternatively, the container, the closure, and reservoir with its extension. The reservoir is typically larger than the extension and the extension is typically conical and larger superiorly. An internal venting tube, which is molded as an extension of the closure, has its superior aspect open to the outside ambient air and its inferior aspect open to the volumetric center of the reservoir, thereby providing double venting. The internal venting tube eliminates the need for an additional component for the flow of air, which is unique to this invention. Previously, the internal venting tube, which required the attachment of another component for functioning, is now a component of the closure, thereby eliminating the need for attachment of another component for proper functioning.

In the preferred embodiment, the invention operates when liquid is introduced into the container, which then is sealed during manufacturing. Optionally, the container may be filled by the consumer. As the container is inverted and liquid pours from the container though the liquid aperture and any attached liquid conduit, air enters the air conduit. The air then proceeds into the reservoir and its extension and enters the distal aspect of the container, avoiding contact with the liquid in the container. Air, while traversing the reservoir and its preferable conical extension, expels any liquid remaining in the reservoir extension, thereby allowing uninterrupted venting of the container. A small amount of liquid may enter and be contained in the proximal aspect of the reservoir during pouring of the liquid, and this liquid is returned to the container upon resumption of the upright positioning of the container. A volume of air, equal to the volume of liquid removed, is introduced into the superior aspect of the container during pouring of the liquid from the container, to eliminate the vacuum in the container.

Several embodiments of the current invention may be seen. The venting mechanism of the present invention includes various shapes. The components of the embodiments may reside in different locations within the invention and relative to one another.

In another embodiment, a venting tube is conically shaped along its entire length. Alternatively, the venting tube may be cylindrical though its length. In embodiments of the current invention, the venting tube extends from outside the container or closure to the distal, internal aspect of the container, such that it is preferably above the level of the liquid in the container when the container is inverted to empty the liquid from the container. This ensures continuous and full venting of the container without aeration and contamination of the liquid in the container. It also ensures that a positive pressure is present in the container, so that the liquid may be withdrawn from the container on demand, without the interference of vacuum, which is present in traditional containers. Alternatively, the venting tube may be of any size or shape and any reservoir present may be of any size or shape and may contain an optional internal vent tube. Also, any venting tube may contain a flange to retain the venting tube in position and may also contain an internal flange to retain liquid and prevent leakage. Leakage is also prevented due to the diameters of the vent and pouring apertures. The range of proportions of internal diameters of the venting tube to the pouring aperture, approximately 1:2.5 (venting tube internal diameter: liquid aperture) allows for rapid and simultaneous reentry of the liquid inside the venting tube into the container followed by air entry above the level of liquid when the container is inverted.

Thus, for the first time, utilizing a one piece—venting mechanism, continuous and full venting, without leaking, without aerating, and without contaminating the liquid in the container takes place, while providing a positive pressure in the container, for removal of liquid on demand without the interference of vacuum, as seen in traditional containers. An additional embodiment shows a flange at the superior aspect of the venting tube to retain the tube in position and a thickening of the internal wall of the superior wall of the vent, which may help retain fluid within the venting tube during unusual situations. Preferably the vent tube has a generally conical shape throughout its entire length. In other embodiments, a conical shape may extend for a variable distance of the tube and it may have a distinct shape at and for any portion of its length, and may be attached in any fashion, either directly or indirectly, to the closure, dispenser, or body of the container.

Alternatively, the container vent locates superiorly to the closure or in another position on the container or associated parts and includes a double-venting reservoir with an associated reservoir extension projecting inferiorly from the inferior aspect of the reservoir to approximate the inferior and lateral edge of the container. The vent may be variably shaped. An air conduit extends distally from the superior aspect of the reservoir preferably into the volumetric center of the reservoir and is in contact with the ambient air outside the liquid container. The reservoir is larger in diameter than its extension. The reservoir and its extension may consist of one or more pieces. The reservoir extension projects to the inferior aspect of the container, and may be attached to the reservoir with a press fit and may be of any length to adjust to the size of the container. The reservoir and its extension may be of any size and shape. Preferably, the extension of the reservoir is not linear to the air conduit of the reservoir. This prevents any liquid that may enter the reservoir during usage from access to the air conduit in the superior aspect of the reservoir. The reservoir and its accompanying superiorly located air conduit and inferiorly located extension are attached or preassembled to the closure or other aspects of the container or associated parts.

Both the extension of the reservoir and the venting tube embodiments may be preferably composed of a buoyant material or a material that is shaped to seek the superior aspect of the container while in the inverted position, which is accomplished by them floating, by their shapes leading to the airspace, or any other means of positioning themselves to reside in the airspace of the container during usage, to minimize any contact of the liquid with air. Different combinations of these components would be preferable in certain containers.

In another embodiment, the second aperture communicates with the venting tube, with the tube approximating the aperture and extending into the container, preferable to the inferior aspect of the container, and preferably superior to the liquid of the container when the container is inverted.

Alternatively, the second aperture of the closure approximates the reservoir with its air conduit and the extension of the reservoir and extends through the length of the container from the proximal to the distal ends. The reservoir may have a position on the superior aspect of the closure, but may have a position in any location, including the interior of the container. Any ends of the apertures and conduits may contain caps. The reservoir and its extension, as well as a venting tube, may be packaged individually or together to be used with a closure, container, air and/or fluid conduits, or any combination thereof.

In the venting tube embodiment of the invention, while in the upright position, has liquid in the venting tube, and when the container is inverted during usage, the inwardly moving air expediently evacuates this liquid into the interior of the container and conducts the air concurrently to the superior aspect of the inverted container, while ensuring no contamination of the liquid in the container with air. In this embodiment, the venting tube, with its preferred conical shape, ensures that the liquid within it, while in the upright position, remains in the tube. Also, the tube assures that during usage, liquid does not exit the container because the liquid is rapidly evacuated from the conically or otherwise shaped venting tube back into the container during inversion and usage of the container. This is accomplished by air quickly entering the tube to vent the container during usage. Both the volume of air in the superior aspect of the conically or otherwise shaped tube and the differential amounts of air in the two ends of the conically or otherwise shaped venting tube along with the approximate ratio of the venting tube to pouring aperture contribute to the unique ability of the venting tube to quickly evacuate the liquid within the tube. The venting tube resting in the airspace of the container during inversion and usage also contributes to venting, as the liquid in the venting tube doesn't have to displace any liquid overlying the venting tube in order to enter the container.

Also, in one embodiment, the superior aspect of the conical or other shape of the venting tube assists in holding any remaining liquid in the venting tube when the container is inverted for usage. This may be done by any reservoir or material in the internal portion of superior aspect of the venting tube. In addition, the vent ensures that the desired rate of pouring of liquid to the exterior of the container is obtained, that an even rate of pouring of liquid out of the container is obtained, that the liquid comes out the container upon inversion of the container during usage without hesitancy, and that there is no initial large egress of liquid from the container with initial inversion of the container. Another embodiment consists of the conical or otherwise shaped vent located on the interior of the container, contoured to the container, closure, or liquid dispenser, ending in the inferior aspect of the container, such that air is channeled to the inferior aspect of the container. Another embodiment shows a check valve in one or more portions in order to prevent the flow of liquid out of the vent, and subsequently the container, while the vent allows for the entry of air into the container as liquid is removed from the container. Also, the invention and its embodiments preferably seek the superior aspect of the container during usage to minimize any contact of the liquid with air. Flanges may be present in any configuration externally to assist with tube positioning and internally to assist in prevention of leakage of fluid from the container in certain embodiments. In addition, all surfaces of the invention may consist of various textures, various degrees of smoothness, and various shapes in order to enhance the return of liquid to interior of the container during usage.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved vent for wine, liquor, and other fluid containers that do not contaminate liquid in the container with air during usage, particularly pouring.

Another object of the invention is to provide a vent that is proportional to the pouring aperture, such that full and continuous venting will occur, with no aeration of the liquid, no spilling of the liquid through the vent, and a positive pressure in the container.

Another object of the invention is to provide such a vent that supplies air to the bottom and superior aspect of the container during removal of liquid from the container in usage.

Another object of the invention is to provide such a vent so that no vacuum forms in the container.

Another object of the invention is to provide such a vent that liquid may be removed from the container on demand because of the absence of a vacuum in the container.

Another object of the invention is to provide such a vent that accommodates containers of various sizes.

Another object of the invention is to provide such a vent that is primarily a linear vent for venting a container.

Another object of the invention is to provide such a vent so that an internal or external closure may be utilized to close the container.

Another object of the invention is to provide such a vent that does not use an insert resting on the superior aspect of the container.

Another object of the invention is to provide such a vent that may be oriented in any direction.

Another object of the invention is to provide such a vent that may be used in any direction without leakage.

Another object of the invention is to provide such a vent that no leakage occurs with dispenser compression in any container direction.

Another object of the invention is to provide such a vent that fits upon any size container neck.

Another object of the invention is to provide such a vent that no leakage occurs with increasing amount of pressure and with increasing dispenser size.

Another object of the invention is to provide such a vent that no leakage will occur with the reservoir in an inverted position.

Another object of several embodiments of the invention is to provide such a vent that any residual fluid in a conical venting tube, a reservoir, or a distal reservoir extension is captured in the dependent aspect of the conical venting tube, a reservoir, or a distal reservoir extension during usage and then returned to the container upon upright positioning.

Another object of the invention is to provide such a vent that no leakage will occur with increasing container neck size.

Another object of the invention is to provide such a vent that does not function at the sidewall of the reservoir thus preventing the requirement for a specific orientation to prevent leakage.

Another object of the invention is to provide such a vent that has its air conduit located in the volumetric center of the reservoir thus eliminating the need for orientation of the container to prevent leakage.

Another object of the invention is to provide such a vent that may be used at any angle.

Another object of the invention is to provide such a vent that does not introduce air bubbles.

Another object of the invention is to provide such a vent that does not form a vacuum within itself or adjacent components of a container.

Another object of the invention is to provide such a vent that allows for positive pressure formation in the container.

Another object of the invention is to provide such a vent where its distal reservoir extension clears itself of any liquid due to consistent airflow into the venting unit during usage.

Another object of the invention is to provide such a vent that provides a predictable stream of liquid during pouring.

Another object of the invention is to provide such a vent that allows for easy measurement of the amount of liquid dispensed.

Another object of the invention is to provide such a vent that permits ready production of the reservoir and the extension because of a single uncomplicated molded part.

Another object of the invention is to provide such a vent that may be made of one part.

Another object of the invention is to provide such a vent that lacks vent attachment incompatibilities.

Another object of the invention is to provide such a vent that does not require tools for its assembly.

Another object of the invention is to provide such a vent that has its reservoir and distal reservoir extension thoroughly supported by the closure of any other desirable portion of the container.

Another object of the invention is to provide such a vent that does not permit over tightening of the collar and an interruption in venting.

Another object of the invention is to provide such a vent that does not require drilling a hole into the neck of the container for it to work.

Another object of the invention is to provide such a vent that does not have a press fit into a hole in the neck of the container.

Another object of the invention is to provide such a vent that may be disassembled and thoroughly cleaned of all matter and bacteria.

Another object of the invention is to provide such a vent that has cleanable and thus reusable parts.

Another object of the invention is to, provide such a vent that is readily marketable to the consuming public through existing supply outlets.

Another object of the invention is to provide such a vent that solves recognized problems in liquid contamination and vacuum formation.

Another object of the invention is to provide such a vent that retains the quality of liquid product because air is not introduced into the liquid.

Another object of the invention is to provide such a vent that prevents oxidation of liquid with vent usage.

Another object of the invention is to provide such a vent that inhibits and prevents chemical reactions that change and alter liquid within the container during vent usage.

Another object of the invention is to provide such a vent that prevents changes in liquid odor with vent usage.

Another object of the invention is to provide such a vent that stops any changes in the color of the liquid during with vent usage.

Another object of the invention is to provide such a vent that prevents changes in the taste of the liquid with vent usage.

Another object of the invention is to provide such a vent that hinders any changes in the liquid from the vent usage that would adversely affect the value of the liquid in the container.

Another object of the invention is to provide such a vent, of many shapes but preferably its conical shape, that liquid within the reservoir exits and returns to the container during upright positioning and does not leave the container.

Another object of the invention is to provide such a vent, of many shapes but preferably its conical shape, that the liquid rapidly evacuates from the distal reservoir extension back into the container during inversion and usage of the container.

Another object of the invention is to provide such a vent, of many shapes but preferably its conical shape, that the user obtains a desired rate of pouring of liquid to the exterior of the container.

Another object of the invention is to provide such a vent, of many shapes but preferably its conical shape, that the user obtains an even rate of pouring of liquid from the container.

Another object of the invention is to provide such a vent, of many shapes but preferably its conical shape, that the liquid pours from the container upon inversion during usage of the container without hesitancy.

Another object of the invention is to provide such a vent, of many shapes but preferably its conical shape, that no initial undesirable large egress of liquid from the container occurs upon initial inversion of the container during usage.

Another object of the invention is to provide such a vent that the distal reservoir extension and the conical venting tube both preferably seek the distal and lateral aspect of the container during usage, thus minimizing any contact of the liquid with air.

Another object of the invention is to provide such a vent that it is inexpensive to manufacture and is disposable.

Another object of the invention is to provide such a vent that uncomplicated to manufacture.

Another object of the invention is to provide a vent that vents air into the venting tube and enables rapid and efficient removal of liquid from the conical venting tube and the distal reservoir extension during usage.

Another object of the invention is to provide more attachments to the superior aspect of a container or closure utilizing continuous, complete, automatic, non-leaking, non-aerating, positive pressure one-piece vent and pouring combination utilizing one direct venting aperture such that the container contents exit onto any desirable surface that assists in feeding or any other purpose. One example is that an item such as a spoon may be attached to the end superior aspect of the container, and the contents of the container may be deposited on the spoon and then consumed.

Other variations and modifications to the subject matter of this invention may be considered to those skilled in the art upon review of the invention as described herein. The ideas presented are not intended to limit the scope or application of the device, or its method of usage.

These together with other objects of the invention, along with the various features of novelty that characterize the invention, are pointed out with particularity in the claims annexed to and forming a part of this disclosure

Other variations and modifications to the subject matter of this invention may be considered to those skilled in the art upon review of the invention as described herein. The ideas presented are not intended to limit the scope or application of the device, or its method of usage. These, together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention. In accordance with these and other objects, the present invention will now be described with particular reference to the accompanying drawings.

### BRIEF DESCRIPTION OF THE DRAWINGS

In referring to the drawings,

FIG. 1 is a front view of a liquid container;

FIG. 2 is a front view of a liquid container pouring into another vessel;

FIG. 3 is a detailed view of a reservoir connecting to the closure in the preferred embodiment;

FIG. 3A shows a side view of an alternate embodiment of the closure with an off center aperture that receives a nipple;

FIG. 3B shows a side view of an alternate embodiment of the closure with a centered aperture that receives a nipple;

FIG. 4 is a sectional view of reservoir connected to closure with alternate embodiment of a check valve;

FIG. 5 is a side view of a liquid container containing the conical vent and pouring aperture;

FIG. 6 is a top view of a liquid container containing the conical vent and pouring aperture;

FIG. 7 is side view of a liquid container containing the conical vent with optional flanges both external and internal to the diameter of the venting aperture;

FIG. 8 is a side view of a liquid container containing the cylindrical vent and pouring aperture;

FIG. 9 is a top view of a liquid container containing the cylindrical vent and pouring aperture;

FIG. 10 is side view of a liquid container containing the cylindrical vent with optional flanges both external and internal to the diameter of the venting aperture;

FIG. 11 is a side view of a liquid container having a conical reservoir and a cylindrical reservoir extension;

FIG. 11a is a side view of a liquid container having a cylindrical reservoir and a conical reservoir extension;

FIG. 12 is a side view of a liquid container having a conical reservoir for its full length;

FIG. 13 is a side view of a liquid container having a conical reservoir for its full length where the reservoir opens through the closure using an aperture;

FIG. 14 is a sectional view of a liquid container having a cylindrical reservoir that opens at the closure and then tapers for its full length;

FIG. 14A is a sectional view of a liquid container and vent as in FIG. 14, and additionally has a flanged end opening at the closure;

FIG. 15 is a side view of a liquid container having a conical reservoir opening at the closure with a cylindrical reservoir extension;

FIG. 16 is a side view of an alternate embodiment of the liquid container where a conical reservoir opens in the neck of a container;

FIG. 17 is a side view of an alternate embodiment of the liquid container where a conical reservoir opens below the neck of a container;

FIG. 18 is a side view of an alternate embodiment of the liquid container where a conical reservoir opens in the wall of a container well below the neck;

FIG. 19 is a side view of an alternate embodiment of the liquid container similar to FIG. 16 but where an upper extension from a conical reservoir opens in the neck of a container;

FIG. 20 is a side view of an alternate embodiment of the liquid container similar to FIG. 17 but where an upper extension from a conical reservoir opens below the neck of a container;

FIG. 21 is a side view of an alternate embodiment of the liquid container similar to FIG. 18 but where an upper extension from a conical reservoir opens in the wall of a container well below the neck;

FIG. 22 is a top view of a liquid container including the plug or stopper of an embodiment of the present invention;

FIG. 23 is a sectional view of the closure and appended reservoir with flexible conduit of an alternate embodiment of the invention;

FIG. 24 is a side view of an alternate embodiment of the liquid container where the closure is inserted into the neck of the container and has a conical reservoir and a cylindrical reservoir extension;

FIG. 25 is a side view of an alternate embodiment of the liquid container where the closure is inserted into the neck of the container and has a conical reservoir for half its length and a cylindrical reservoir extension;

FIG. 26 is a side view of an alternate embodiment of the liquid container where the closure is inserted into the neck of the container and has a conical reservoir and a cylindrical reservoir extension;

FIG. 27 is a side view of an alternate embodiment of the liquid container where the closure is inserted into the neck of the container and has a conical reservoir for its full length;

FIG. 28 is a side view of an inverted liquid container including the closure within the neck of a container for an alternate embodiment of the present invention;

FIG. 29 is a side view of an alternate embodiment of the liquid container where the closure is inserted into the neck of the container and has a conical reservoir and a flexible air conduit;

FIG. 30 is a side view of an alternate embodiment of the liquid container where the closure is inserted into the neck of the container and has a conical reservoir for half its length and a flexible air conduit;

FIG. 31 is a side view of an alternate embodiment of the liquid container where the closure is inserted into the neck of the container and has a conical reservoir for over half its length and a flexible air conduit; and,

FIG. 32 shows perspective view from below of an alternate embodiment of the closure with an off center liquid spout and a check valve for the liquid spout.

The same reference numerals refer to the same parts throughout the various figures.

FIG. 33 shows an embodiment of the invention with one of any configuration of attachments to the container or closure, which allows for various consistencies of liquids or solids to be dispensed from the container and presented when desired in any amount and from any type of surface.

These same reference numerals refer to the same parts throughout the various figures.

### DESCRIPTION OF THE PREFERRED EMBODIMENT

The present invention overcomes the prior art by providing a venting tube enabling return of any liquid in the venting tube back into the container without leakage out of the container. The present invention provides a vent to overcome the disadvantages of the prior art by providing a liquid aperture, an air aperture, and a venting mechanism of various shapes and proportions to simultaneously vent a container and prevent leakage from the container while utilizing a preferably conical mechanism and utilizing only one additional part to the container and closure. Additionally, double venting and a reservoir are utilized.

Another embodiment of the present invention overcomes the prior art limitations by providing a closure, venting, and related components that fit on or within the neck of a liquid container, such as a wine bottle, sports bottle, or other container, and minimizes the mixing of air with liquid not yet poured from the container while eliminating spillage from the container during pouring.

Another embodiment utilizes a vent tube. The vent tube extends from the exterior of the container to the interior inferior aspect of the container.

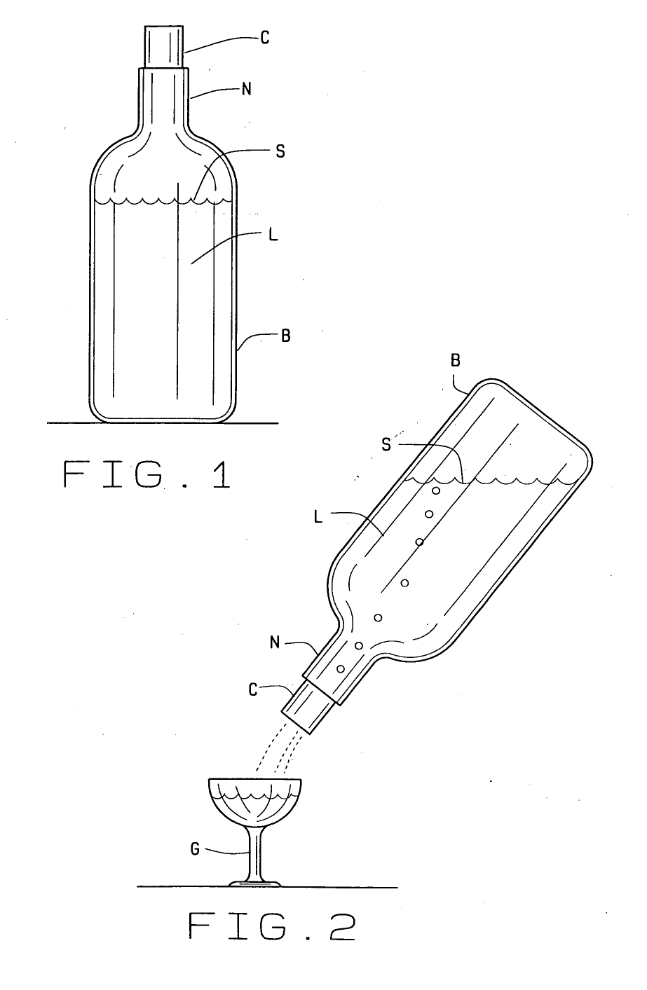

FIG. 1 illustrates a liquid container B, which is illustrative of the prior art, with liquid L placed therein. The liquid has a surface S denoting the top of the liquid, above which any air in the container collects. The container B has a narrow neck N generally centered upon the container and extending outwardly from the main portion of the container. The container has a closure as at C upon the neck that retains the liquid within the container following manufacture and keeps air out of the container prior to opening.

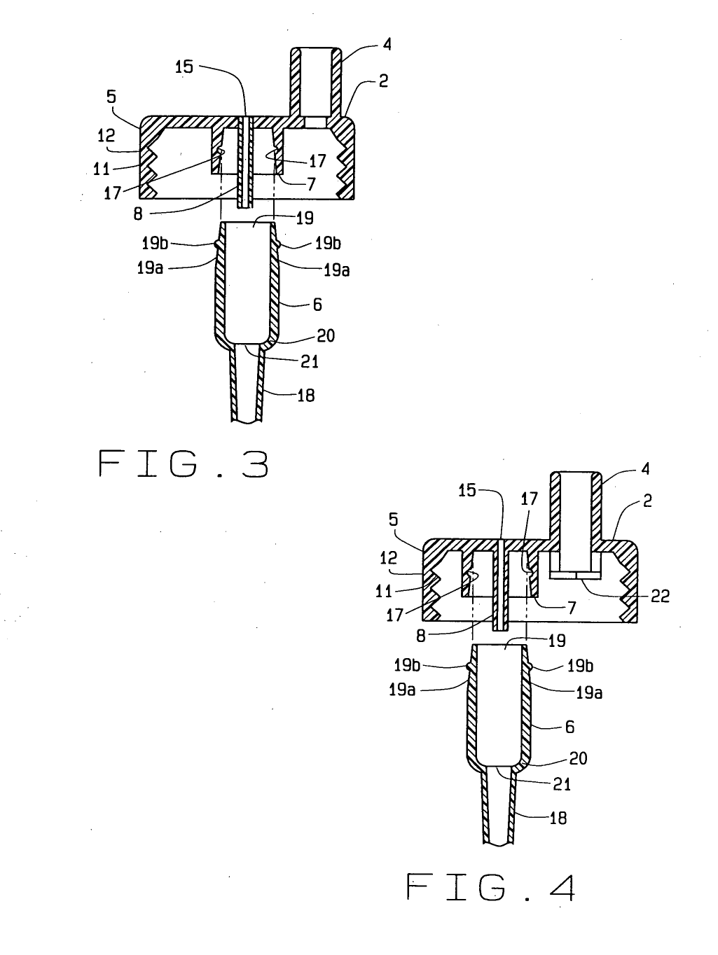

To consume the liquid in a prior art container, a user removes the closure C and then grasps the container. During usage of a container B, that is, pouring, a user tips the container and orients the container with the neck N generally downward as shown in FIG. 2. With the neck downward, the bottom of the container B is generally upward which moves the liquid L towards the neck and the surface S in the direction of the bottom. As the liquid exits the neck into a glass G, air enters the neck N and travels through the liquid L and breaks the surface S to locate above the liquid. As described above, air passing through the liquid in most of the prior art introduces various reactants and pollutants into the liquid, which is particularly detrimental in those individuals who are rehydrating and consuming large amounts of liquids. This affects most particularly those in sports that are intense and require optimal heart rate control, as air introduction into the stomach, which causes stomach distension, disrupts the body's automatic heart rate adjustments that are necessary for optimum performance. Also, those with a discriminating palate can detect alterations to the liquid brought on by the passage of air through the liquid.

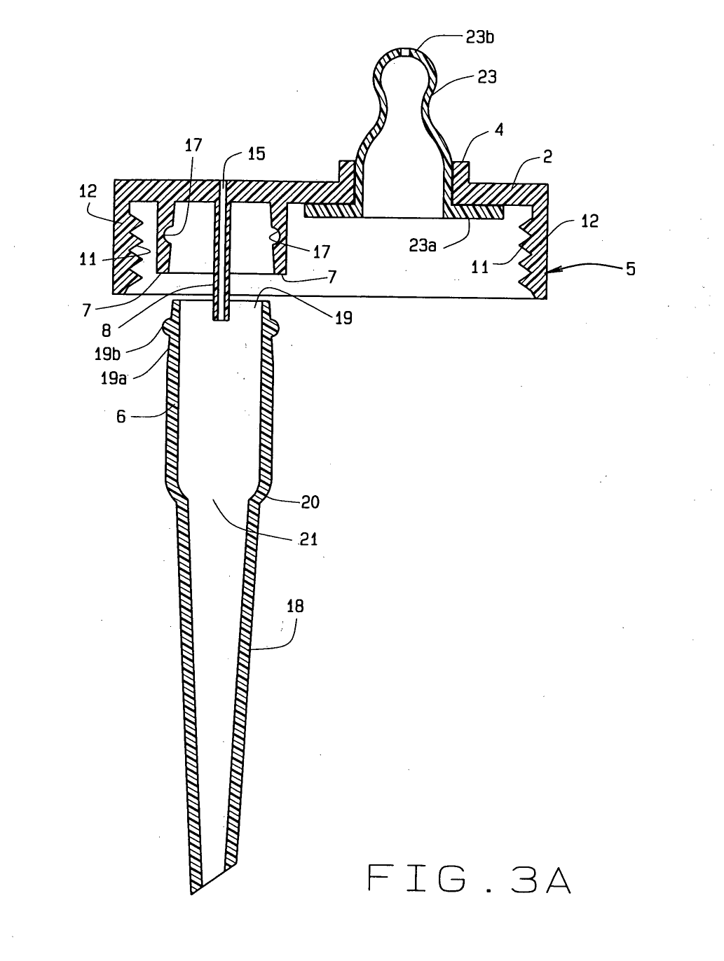

FIG. 3, the preferred embodiment, a closure 5 is noted. The closure allows for passage of both air and fluid through appropriate passages without fluid entering the air passage and vice versa. If mixing of air and liquid do occur, as they do in the prior art, leaks and ingestion of air during intake occur. The closure 5 turns upon the neck in a threaded connection to the container. The closure 5 has a perimeter flange 12 with internal threads that engage the threads of the neck. The closure has its surface 2, visible to the user, generally perpendicular to the perimeter flange. The surface has a spout 4 formed therein for passage of fluids from the container to a user. The spout is here shown as a round cylinder as seen by a user. Spaced away from the spout, generally centered in the closure, the closure has its aperture 15 for venting of the container during usage, that is, the passage of air. Generally, all embodiments of the invention preferably have the venting mechanism located in the center of the closure. In this embodiment, the aperture represents the exterior opening of an internal venting tube 8. The internal venting tube 8 approximates the surface 2 and passes through the closure 5.The internal venting tube 8 generally has a constant diameter and hollow construction for passage of air there through. Opposite the spout 4, the closure has an accepting flange 7 that extends inferiorly from the closure. The accepting flange is generally round, though here shown as two spaced apart walls in a section view. The accepting flange has a frusto-conical interior shape with a curved recess 17 approximately half way along the depth of the accepting flange. The curved recess defines a plane generally parallel to the surface 2 and extends around the internal circumference of the accepting flange.

The accepting flange receives a reservoir 6, generally a hollow cylinder with an open top 19 and a partially closed bottom 20. The bottom has an aperture 21 from which extends a conically shaped reservoir extension 18. The reservoir in combination with the reservoir extension 18 extends the vent to proximate the bottom of a container. The reservoir has its top slightly beveled inwardly as at 19a where the bevel generally matches the interior frusto-conical shape of the accepting flange. The reservoir superior side wall also includes at least one detent 19b here shown as two protrusions outwardly from the beveled portion of the top as at 19a. The detents can have the form of separate spaced apart protrusions. Preferably, the detents form a ring upon the perimeter of the superior side wall so that the detent fits into the recess 17 of the accepting flange. Alternatively, the reservoir may attach by friction fit or any other attachment to the accepting flange. The detent and the recess cooperate to secure the reservoir to the accepting flange of the closure. The internal venting tube 8 extends into the reservoir when secured to the accepting flange. The internal venting tube generally opens at the volumetric center of the reservoir so that the internal venting tube allows passage of air regardless of the angle of the reservoir, that is, the internal venting tube remains above the surface of any liquid within the reservoir.

FIG. 3A shows an alternate embodiment of the closure 5 where it has an internal venting tube 8 having a aperture 15 on the surface 2. Offset from the aperture, the closure may have a truncated spout 4 having a height above the surface opposite the internal venting tube of approximately the thickness of the closure or consist of any other type of aperture. The closure has an aperture to receive a typical spout, nipple or other aperture 23 typically having a flat flange 23a from which extends a spout, nipple or other aperture 23b. Alternatively, the spout or other form of drinking aperture may come attached to the closure or otherwise be associated with the closure. When installed as shown, the 3 nipple passes its elongated spherical tip through the spout or other aperture 4 and away from the closure. The flat flange of the nipple then abuts the closure opposite the surface 2. The closure has sufficient diameter to provide for the internal venting tube and the accepting flange 7 and the diameter of the flat flange 23a of the spout, nipple or other aperture.

Then FIG. 3B shows another alternate embodiment of the closure 5 with a generally flat surface 2 and a depending perimeter flange 12 as previously described, where it has an internal venting tube 8 having a flush aperture 15 with the surface 2. Centered upon the surface of the closure, this alternate embodiment has a shortened spout or other aperture 4 which may have a height above the surface. The closure has an aperture to receive a typical spout, nipple or other aperture 23 having a flat flange 23a from which extends a spout, nipple or other aperture, and which may consist of an elongated spherical tip 23b as known in the art. When installed as shown, the nipple passes its elongated spherical tip through the spout 4 and away from the closure. The flat flange of the nipple then abuts the closure opposite the surface 2. The closure has sufficient diameter to provide for the internal venting tube and the accepting flange 7 and the diameter of the flat flange 23a of the nipple. The accepting flange is generally round and concentric with the internal vent tube. The accepting flange 7 has the recesses 17 partially along its length that receive the detents 19b from the reservoir as shown.

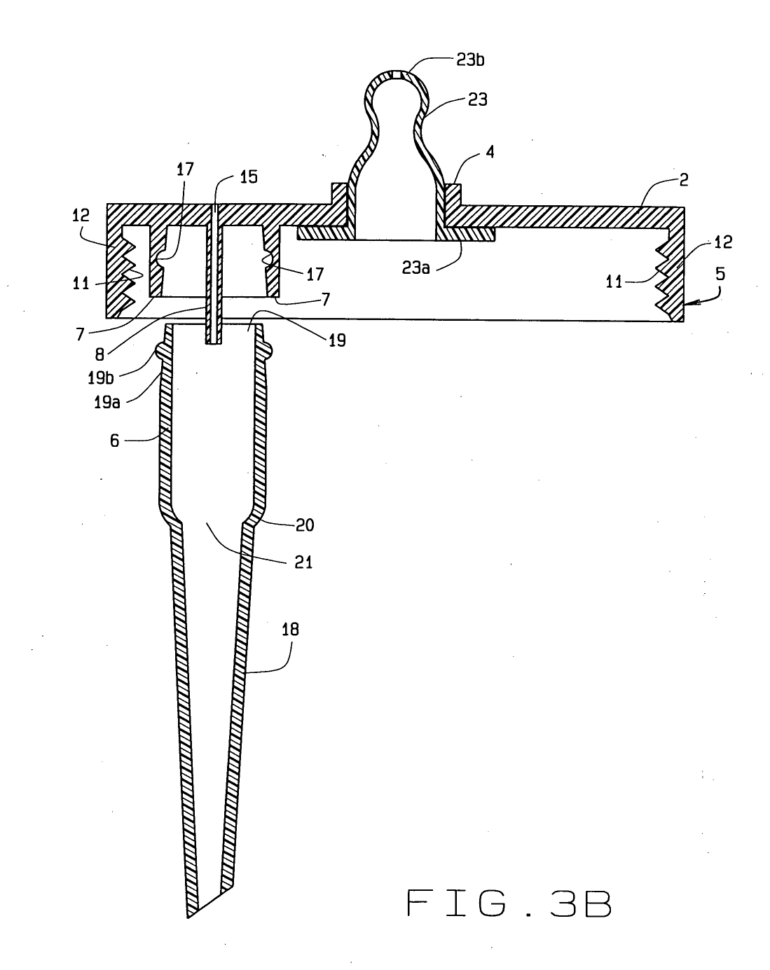

FIG. 4 shows, as above, the reservoir 6 fits its top 19 into the accepting flange 7 with the internal venting tube 8 extending into the volumetric center of the reservoir. The top of the reservoir secures to the accepting flange as the detent 19b engages the recess 17. Offset from the aperture 15, this embodiment of the closure has its spout 4 typically of greater diameter than the internal venting tube 8. The spout extends generally perpendicular to the surface 2 of the closure with the majority of the spout outwardly from the surface. The spout also extends generally parallel to the internal venting tube 8 and within the perimeter flange 12. The spout has two opposite ends, one end opening to the atmosphere away from the closure and another end locating into the closure. The other end of the spout includes an optional check valve 22. The check valve allows passage of liquids outwardly from the closure but prevents introduction of liquids and gases through the spout and the check valve into the container. Typically, the check valve forms integrally with the closure. In an alternate embodiment, the check valve is a separate component attached to the closure during manufacturing.

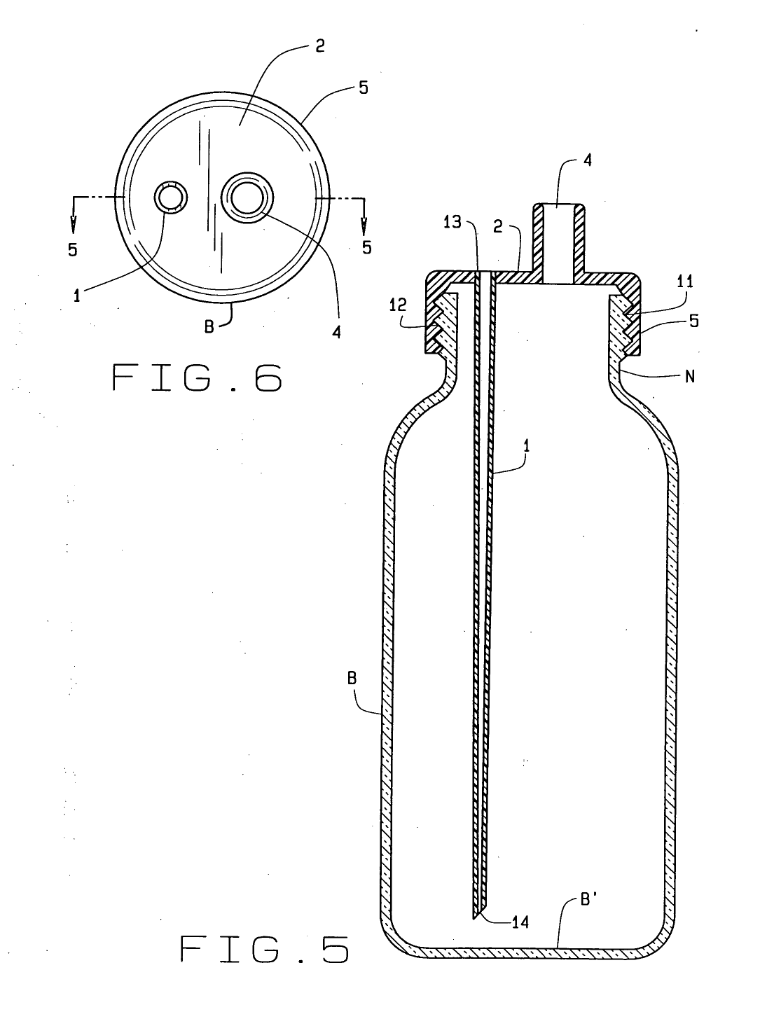

FIG. 5 shows the side view of the liquid container and demonstrates the preferably conical venting tube extending from the top of the container to the inferior aspect of the container. Here, the closure 5 secures upon a neck N of the container, here shown as a bottle, though other containers are foreseen. The neck extends upwardly from an end, generally the top, of the bottle. The neck has external threads that engage internal threads 11 upon the interior of a perimeter flange 12 of the closure. The flange extends around the perimeter of the closure generally perpendicular to a surface 2 of the closure through which pass the vent 1 and the spout 4. In this view, the vent passes flush through the closure, as at 13, and enters the container. The vent is generally elongated, hollow, and tapered as it extends beyond the closure inferiorly to proximate the bottom, as at B′, of the bottle. The vent typically tapers at least ½ of 1% from the closure towards its tip, as at 14, but may taper any amount. The tip also has a slight bevel, that is, angled cut to prevent clogging proximate the bottom. Further, the closure 5 has the spout 4 extending upwardly from the surface 2 or opposite the neck N. In this embodiment, the spout remains integral with the closure while alternatively the spout may be a separate piece inserted into the closure. As in FIG. 1, the spout preferably has an area, here represented by its internal diameter, approximately 2.5 times that of the vent. Generally, when a reservoir is not present, the preferred ratio of the fluid aperture to the venting aperture is 2.5:1 in various embodiments of the invention.

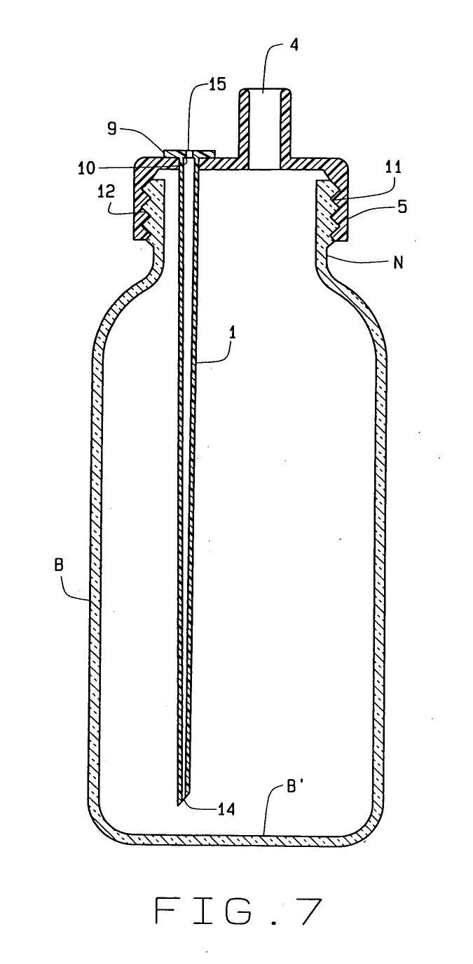

Another embodiment, demonstrated in FIG. 6, shows the top aspect of the liquid container and demonstrates one proportion in the range of proportions of the internal diameters of the pouring aperture and the superior aspect of the preferably conical venting tube. This figure shows the top of a closure for a container B, a vent 1 in the closure 5, and a spout 4 proximate the vent that minimizes the mixing of air with liquid not yet poured from the container. The vent and spout have a proportional relationship generally where the diameter of the spout is generally 2.5 times that of the diameter of the vent. Here the vent and the spout are shown being round so the proportion of the area is reflected in their diameters. Though a round vent and a round spout are shown, the Applicants foresee alternate shapes for the openings provided the ratio of areas remains similar. FIG. 6 generally shows the proportions of the internal diameters of the spout 4 and the superior aspect of the vent 1. Though a closure 5 is shown, the Applicants foresee that the vent and the spout of the invention can be inserted directly into a completely closed top of a container and function similarly provided the proportions of the invention are maintained.

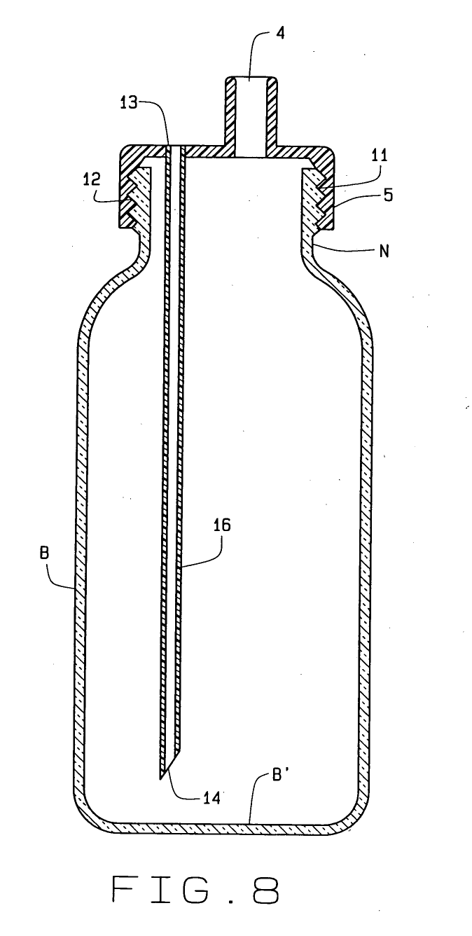

FIG. 7 shows the side view of the liquid container and demonstrates the preferably conical venting tube extending from the top to the bottom of the container. Also demonstrated are optional flanges 9, 10. Optional flange 9 is external to the diameter of the venting tube and may help maintain the position of the venting tube. Optional flange 10 is internal to the venting tube and may help with retention of any fluid in the venting tube while the container is in use. In an alternate embodiment of the invention, FIG. 7 shows the container B as a bottle as in FIG. 5 with a closure 5 upon the neck N. The closure has an integral spout 4 as before. The closure though has an aperture 15 in the surface 2. The aperture allows venting of the container in combination with the spout as is commonly known. This alternate embodiment though provides a vent 1 placed through the aperture generally tapered as before but with a stop flange 9 upon one end of the vent with the other end of the vent having a beveled cut, as at 14, as previously described. The stop flange extends around the perimeter of the vent and outwardly from the vent. The stop flange prevents the vent from falling through the aperture and into the bottle. Further, the stop flange continues inwardly as a retainer flange 10 that partially closes the vent. The retainer flange holds residual fluid in the vent when the container is inverted during usage.

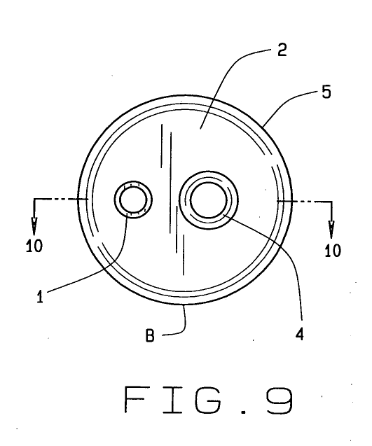

FIG. 8 shows the side view of the liquid container and demonstrates the cylindrical venting tube extending from the top of the container to the inferior aspect of the container. FIG. 8 then shows the closure 5 secured upon a neck N of the bottle but with an alternate embodiment of the vent. As before, the neck extends upwardly from the top of the bottle. The neck has external threads that engage internal threads 11 upon the interior of a perimeter flange 12 of the closure. The flange extends around the perimeter of the closure, perpendicular to the surface 2 of the closure through which pass an alternate embodiment of the vent as at 16 and the spout 4. In this view, the vent passes flush through the closure, as at 13, and enters the container. The vent is generally an elongated, hollow cylinder of constant diameter that extends beyond the closure inferiorly to proximate the bottom, as at B′, of the container. The alternate embodiment of the vent 16 has its tip 14, also with a slight bevel for clog prevention typically close to the bottom. As before, the spout 4 extends upwardly from the surface 2 or opposite the neck N for ease of use. In this embodiment, the spout remains integral with the closure but may also be provided as a separate piece for insertion during manufacturing or by the end user through the closure. All embodiments may utilize a spout integral to the closure, or may attach any spout to the closure. As in FIG. 6, the spout has an area, here represented by its internal diameter, approximately 2.5 times that of the vent.

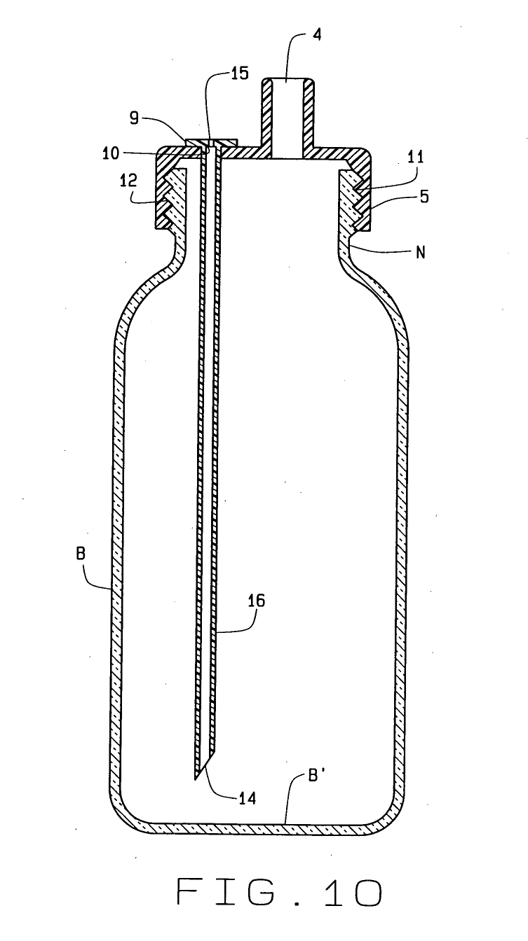

FIG. 9 shows the top aspect of the liquid container and demonstrates one proportion in the range of proportions of the internal diameters of the pouring aperture and the superior aspect of the cylindrical venting tube. This figure shows the top of a closure for a container C, a vent 1 in the closure 5, and a spout 4 along with the vent, that minimize the mixing of air with liquid not yet poured from the container. The vent and spout have a proportional relationship generally where the area of the spout is approximately 2.5 times that of the area of the vent. Here the vent and the spout are shown being round so the proportion of the area is reflected in their diameters. Though a round vent and a round spout are shown, the Applicants foresee alternate shapes for the openings provided the ratio of areas remains similar. FIG. 9 generally shows the proportions of the internal diameters of the spout 4 and the superior aspect of the vent 1. Though a closure 5 is shown, the Applicants foresee that the vent and the spout of the invention can be inserted directly into a completely closed top of a container and function similarly provided the proportions of the invention are maintained.

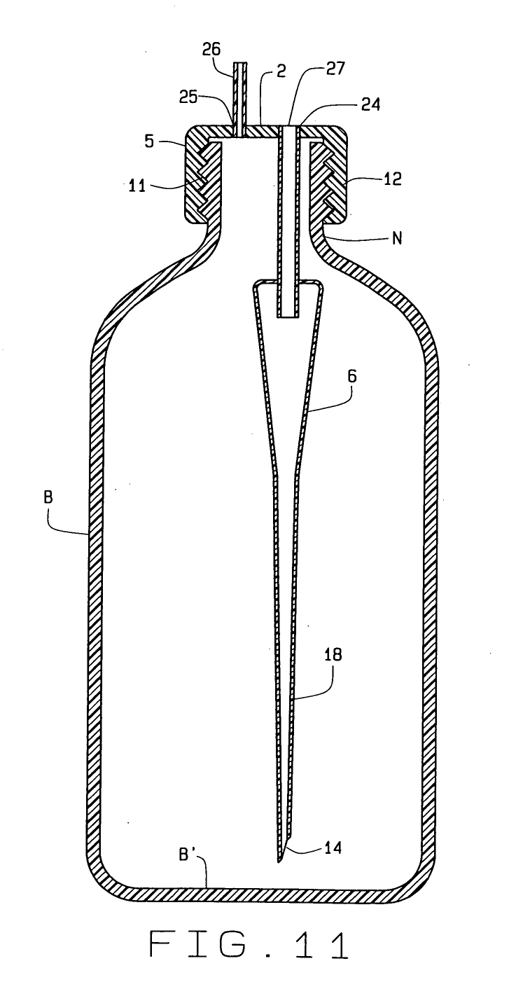

FIG. 10 shows the side view of the liquid container and demonstrates a cylindrical vent tube extending from the top to the bottom of the container. Also demonstrated are optional flanges 9, 10. Optional flange 9 is external to the diameter of the venting tube and may help maintain the position of the venting tube. Optional flange 10 is internal to the venting tube and may help with retention of any fluid in the venting tube while the container is in use. Here this figure shows the container B as a bottle with a closure 5 upon the neck N. The closure has its integral spout 4 and its aperture 15 in the surface 2. This alternate embodiment though provides the vent 16 placed through the aperture generally cylindrical as before but with a stop flange 9 upon one end of the vent with the other end of the vent having a beveled cut, as at 14, as previously described. The stop flange extends around the perimeter of the vent and outwardly from the vent, generally having a greater diameter than the diameter of the aperture 15. The stop flange prevents the vent from falling through the closure and into the bottle. Further, the stop flange continues inwardly as a retainer flange 10 that partially closes the vent, similar to FIG. 7.

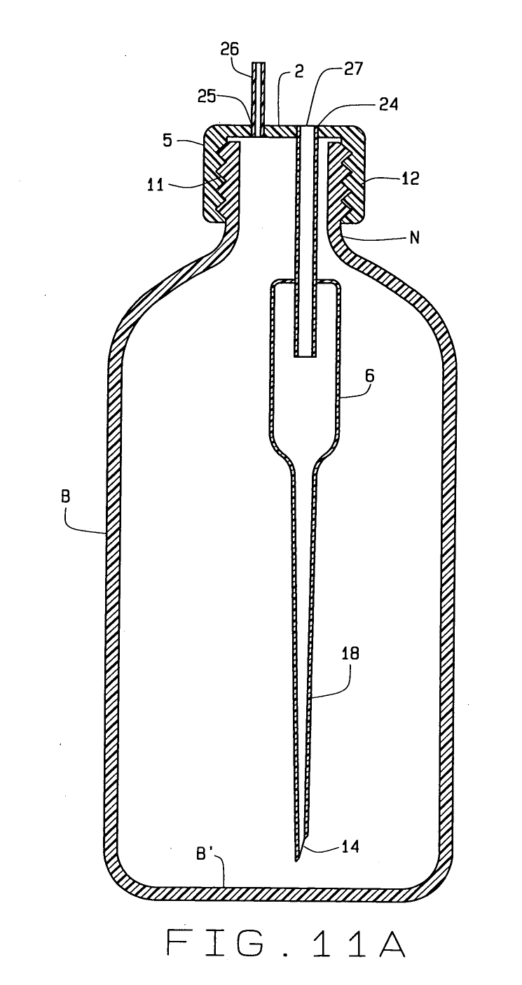

FIG. 11 demonstrates an alternate embodiment of the invention where the container B has a generally narrow neck N. The neck has a closure 5 threadedly engaged to the neck. The closure has its surface 2 as before that has an aperture 24 that vents air into the container and a nearby aperture 25 that passes fluid. This embodiment has a short section of tube utilized as an optional fluid conduit 26 placed through the fluid aperture 25. The closure also admits an external venting tube 27 through the aperture 24. The venting tube is generally elongated and narrow as it extends from the closure into the neck of the container. The venting tube merges with a conical or otherwise shaped (FIG. 11A) reservoir 6, generally at the proximal, or wide end, of the reservoir. Distal to the reservoir, extension 18 extends proximate to the distal end of the container. The reservoir extension typically has a length greater than the reservoir and a generally conical shape with a beveled opening proximate the bottom B′ of the container. FIG. 11A shows a similar embodiment to FIG. 11, and demonstrates a cylindrical rather than conical reservoir 6.

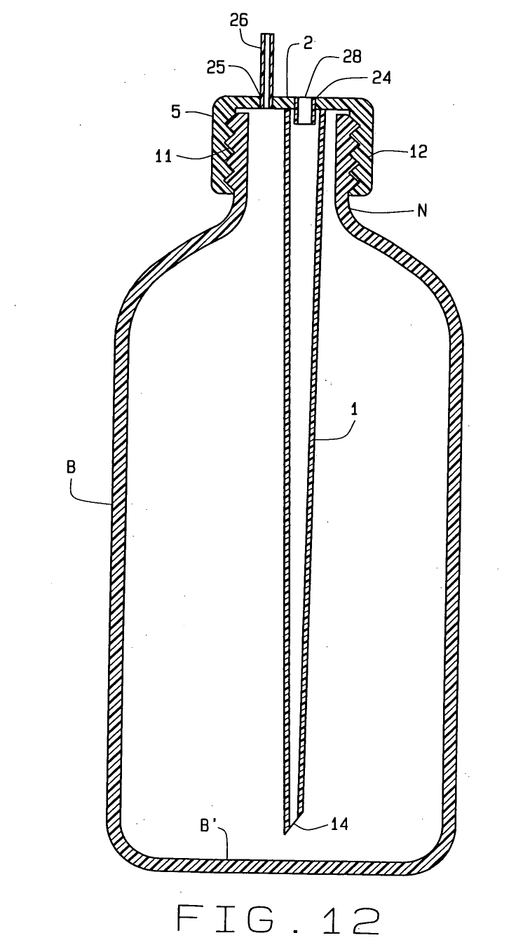

FIG. 12 demonstrates another alternate embodiment of the invention with a narrow neck N upon a container B. The neck has a closure 5 threadedly engaged to it. The neck extends upwardly from an end, generally the top, of the container. The neck has external threads that engage internal threads 11 upon the interior of a perimeter flange 12 of the closure. The flange extends around the perimeter of the closure generally perpendicular to a surface 2 of the closure through which pass the internal vent 28 and the optional fluid conduit 26. The closure has its surface 2 with the air aperture 24 and a nearby aperture 25 that passes fluid. This embodiment has a short section of tube utilized as an optional fluid conduit 26 placed through the fluid aperture 25. The closure also admits a shortened internal venting tube as at 28 through the aperture 24. The air conduit 28 maintains communication with ambient air outside the container B. The air aperture 24 passes the ambient air into the venting tube 1. In this view, the air conduit 28 passes through the closure and enters the container. The vent, as at 1, is generally elongated, hollow, and tapered as it extends beyond the closure inferiorly to proximate the bottom, as at B′, of the bottle. The vent typically tapers at least ½ of 1% from the closure towards its tip, as at 14. The tip also has a slight bevel, that is, angled cut to prevent clogging proximate the bottom. In this embodiment, the air conduit and optional fluid conduit 26 may both be integral to the closure or may be separate pieces. As before, the aperture 25 for liquid passage has an diameter approximately 2.5 times that of the aperture 24 for venting air.

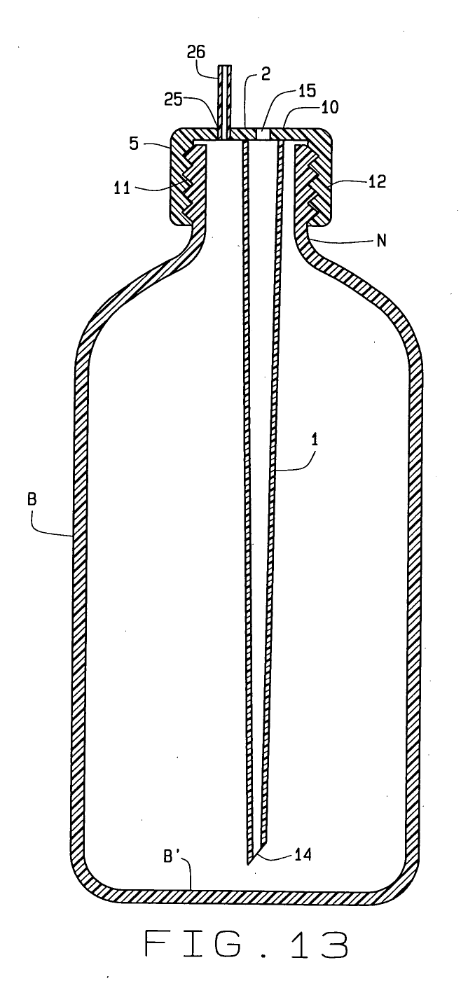

FIG. 13 shows a similar container B with a closure 5 having an aperture 25 for passing liquid through an optional fluid conduit 26 and venting air through an aperture 15 in the surface 2 of the closure. The aperture 15 allows for venting of air through closure 12 but without an air conduit, thus eliminating one part. This figure shows an optional liquid conduit 26 extending into the container. The vent, as at 1, is generally elongated, hollow, and tapered as it extends beneath the closure inferiorly to proximate the bottom, as at B′, of the bottle. The vent typically tapers at least ½ of 1% from the closure towards its tip, as at 14. The tip also has an angled cut to prevent clogging proximate the bottom. As before, the aperture 25 for liquid passage has an area approximately 2.5 times that of the aperture 15 for venting air.

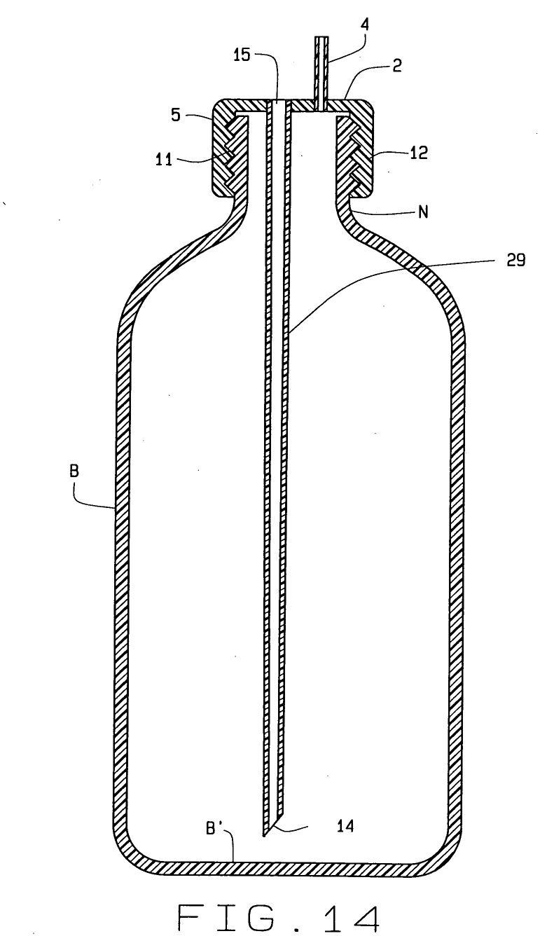

FIG. 14 shows another embodiment of the current invention where the internal venting tube is preferably conical in a distal portion of its length, as at 29, and inserted into the container B. It may be inserted into any aspect of the container or closure. This version of the current invention has an additional advantage in that a current container need only be modified by providing a liquid aperture, an aperture on the surface of container, cap, plug, or similar device, and associating a preferably conical vent to the air aperture. Many parts, costs, assemblies, leaks, time to assemble, and other disadvantages of the prior art vanish when utilizing this version. This figure shows the side view of the liquid container B and demonstrates the conically shaped internal venting tube 29 extending from the surface 2 of the closure to the inferior aspect of the container. As before, the closure 5 secured upon a neck N of the container using threads, internal threads 11 upon the interior of a perimeter flange 12 of the closure. The flange extends around the perimeter of the closure, perpendicular to the surface 2 of the closure through which connects the venting tube as at 15 and the spout 4 shown as a short section of tube extending above and beneath the surface of the closure. In this view, the vent passes through the closure and enters the container. The external venting tube is generally an elongated, hollow cone of various diameters that extends beyond the closure inferiorly to approximate the bottom, as at of the container. This embodiment of the vent 29 has its tip 14, also with a slight bevel for clog prevention so close to the bottom. In this embodiment, the spout remains integral with the closure but may also be provided as a separate piece for insertion during manufacturing or by the end user through the closure. As in FIG. 5, the spout has an area, here represented by its internal diameter, approximately 2.5 times that of the vent.

FIG. 14A demonstrates the addition of an optional stop flange 9 to the superior aspect of the internal venting tube 29. The stop flange extends outwardly from the aperture 15 and prevents the tube 29 from slipping into the container when as a separate piece from the closure. Any of the venting tubes or other portions of any versions may be cleaned and reused or may be disposable.

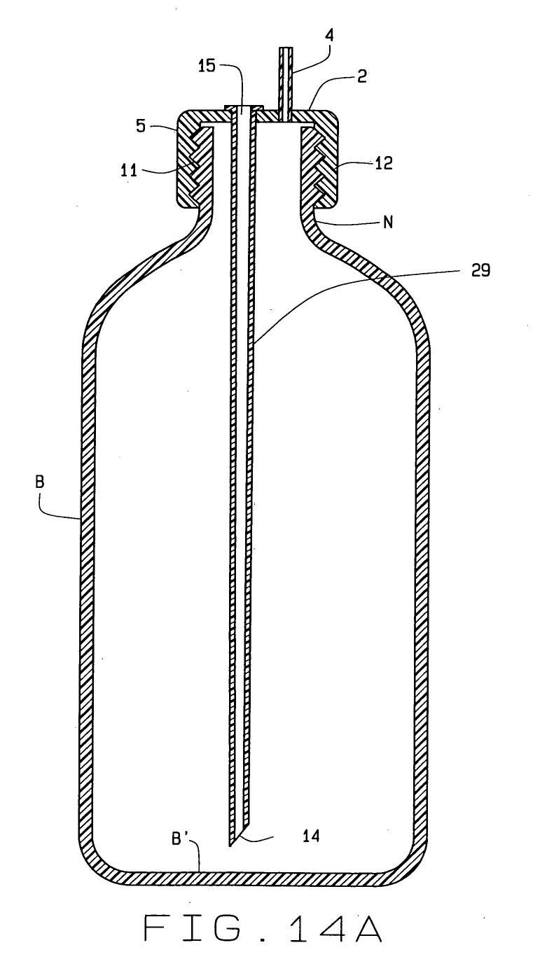

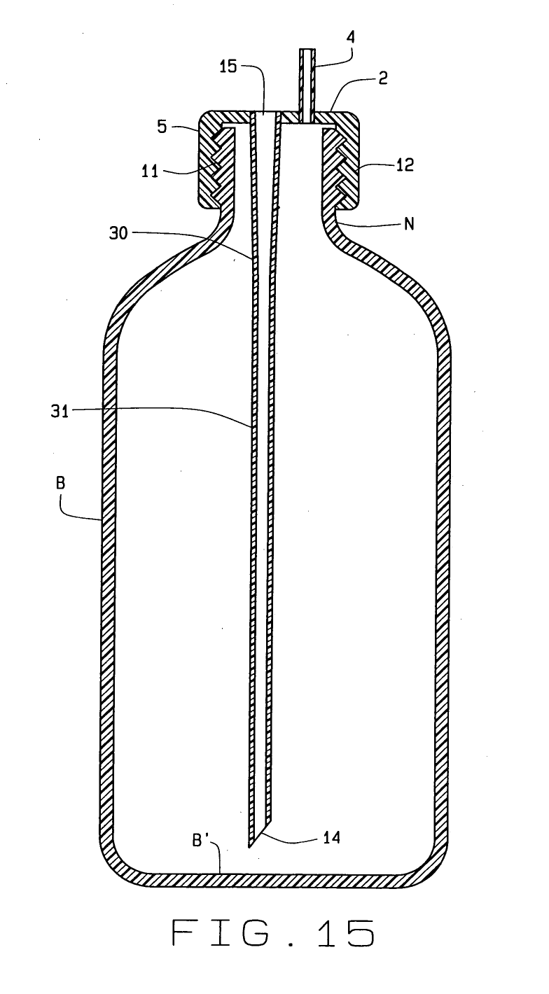

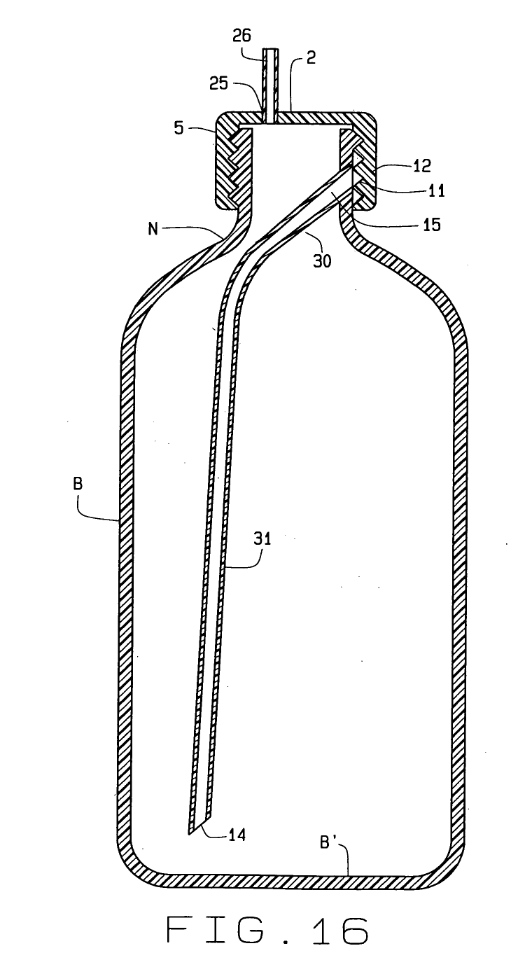

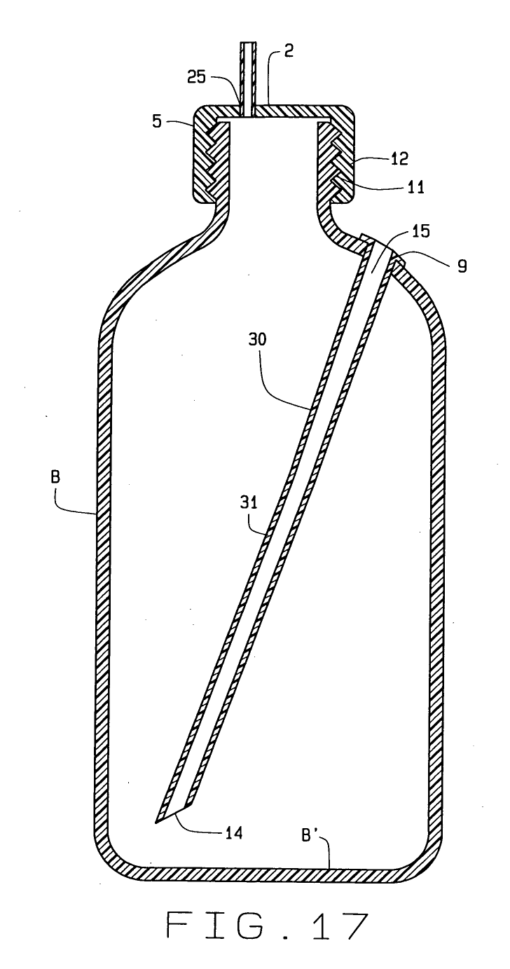

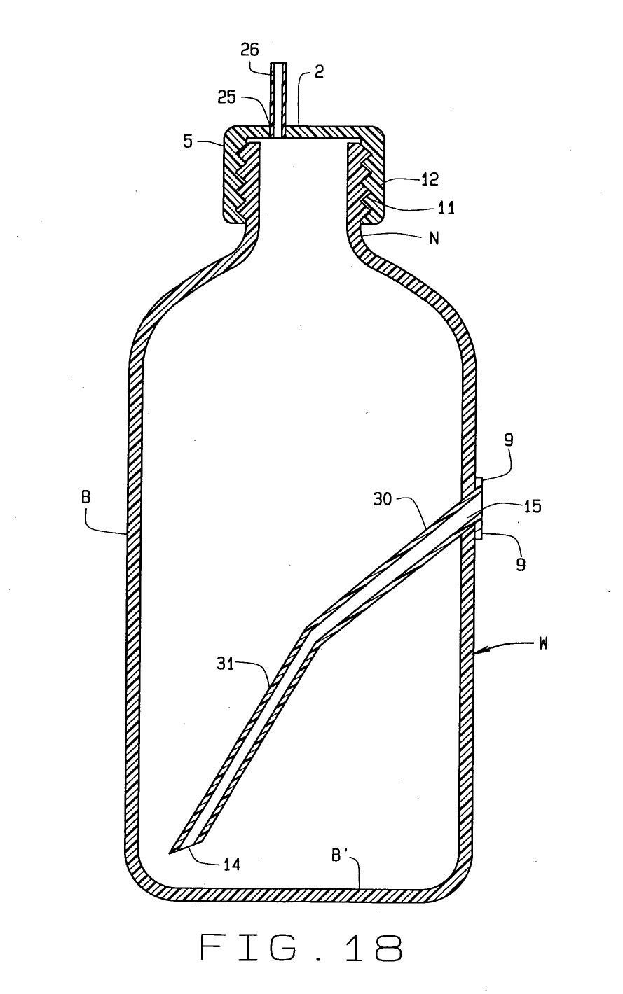

In FIG. 15, the preferably conical vent is situated such that the superior aspect vents as at 15 from the closure 5 and contains a preferably conical aspect in the proximal region as at 30 with a cylindrical vent extension 31 depending from the conical aspect. The vent extension has a length that allows for its opening as at 14 proximate the bottom B′ of the container. The preferably conical aspect may be in any location of the container or closure, as shown in FIGS. 16, 17, 18, or any proportion or aspect of the tube as later shown in FIG. 19. FIG. 16 shows the proximal region 30 opening as at 15 in the threaded region of the neck. FIG. 17 provides an opening 15 beneath the neck N where the proximal region 30 opens and has a stop flange 9 upon its perimeter. The proximal region extends downwardly and inwardly into the container B with the reservoir extension 31 further extending towards a corner of the bottom B′. FIG. 18 next provides the opening 15 of the vent well below the neck N and generally in a wall W. As before, the proximal region 30 of the conical vent opens and utilizes its stop flange 9 to prevent the vent from falling into the container B. The proximal region extends downwardly and inwardly into the container B with the reservoir extension 31 further extending preferably into the airspace of B′.

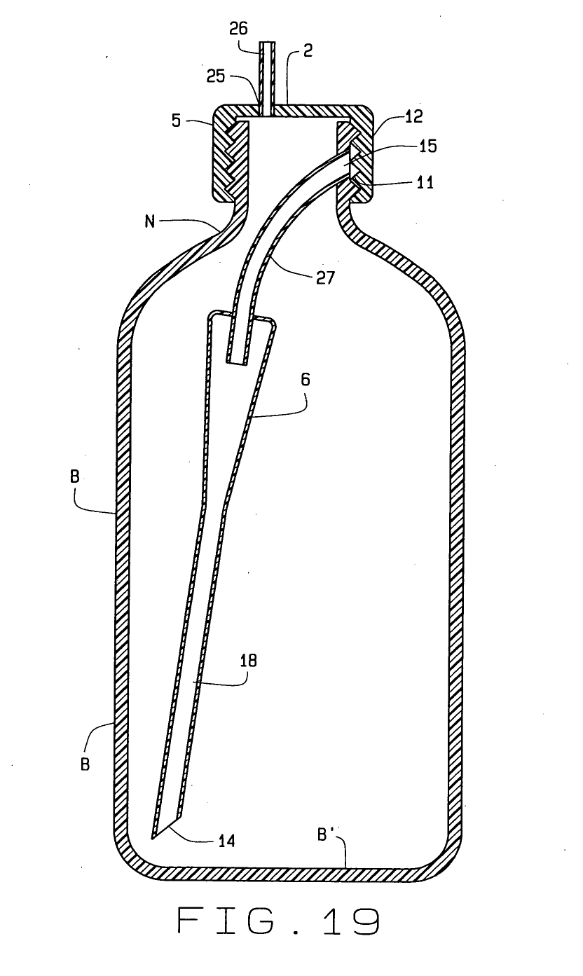

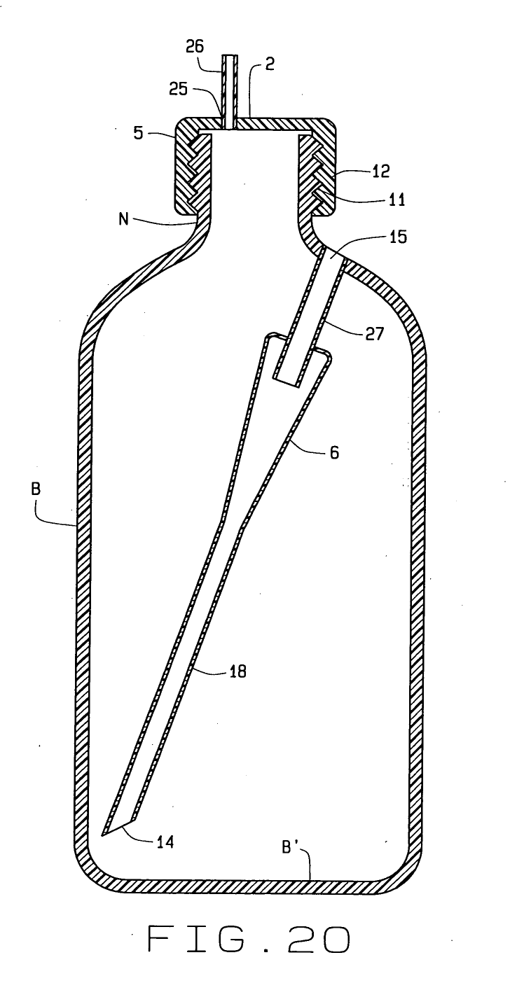

FIG. 19 then shows the proximal vent 27 opening as at 15 in the threaded region of the neck. This alternate embodiment of the invention has the closure 5 threadily engaged to the neck. The closure has its surface 2 as before that has an aperture 25 that passes fluid but not an aperture that vents air as in previous embodiments. This embodiment has a short section of tube utilized as an optional fluid conduit 26 placed through the fluid aperture 25. The neck N of the container admits an external venting tube 27 that opens as at 15. The external venting tube is generally elongated, narrow and curved as it extends from proximate the closure and into the neck of the container. The external venting tube merges with a conically shaped reservoir 6, generally at its wide end as shown. Opposite the external venting tube, the reservoir narrows in diameter to the reservoir extension 18 which typically has a length greater than the reservoir. The generally cylindrical reservoir extension has a beveled opening 14 proximate the bottom B′ of the container. Any combination of the previously described arrangements of closure 5, opening 15, neck N, and the various venting tubes with and without reservoirs meet the performance characteristics of the invention. FIG. 20 further shows the combination of the closure 5 upon a threaded neck N where the external venting tube 27 opens below the threaded portion of the neck. The external venting tube then continues downwardly into the wide end of the reservoir 6 and its depending reservoir extension 18 as shown. And, FIG. 21 has a container B with a neck N closed by the closure 5. This embodiment though has the opening 15 in the wall W of the container. The opening admits the external venting tube 27 for venting air from the atmosphere to the container. The external venting tube then continues to the wide end of the reservoir 6 which then continues to the reservoir extension 18 as shown. In the various embodiments previously shown and described, an optional flange as at 9 and optional internal proximal thickening as at 10 may be present, also in any configuration.

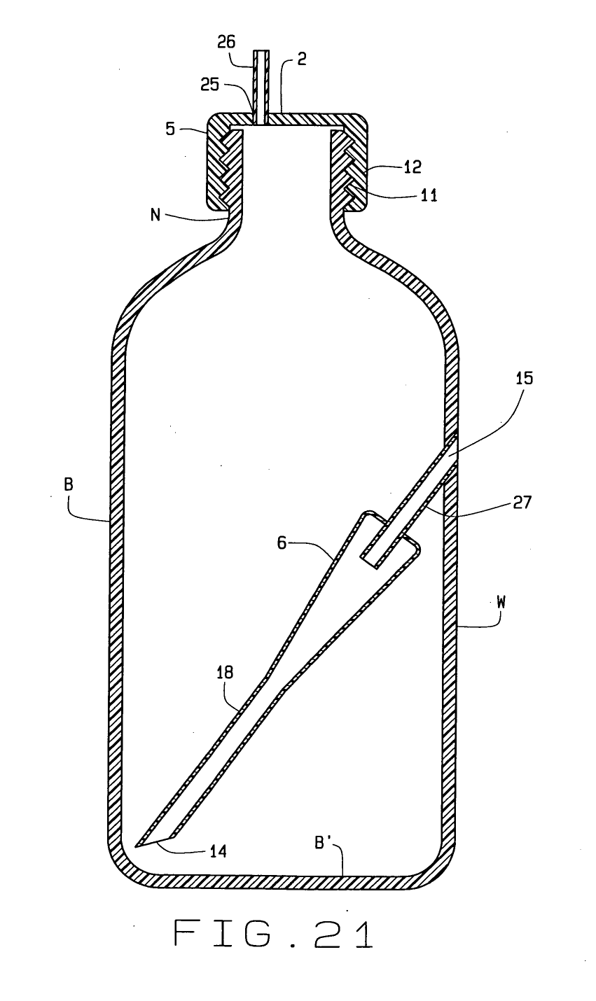

FIG. 22 shows a plug 2, or closure. The plug has a generally round shape to accommodate the shape of a round neck. However, the plug may have an alternate shape to accommodate necks or container openings of other shapes. The venting aperture and pouring aperture are generally located upon a diametrical line across the plug in this embodiment. Alternatively, the venting aperture may have a location spaced away from the pouring aperture so long as air can entered the vent tube.

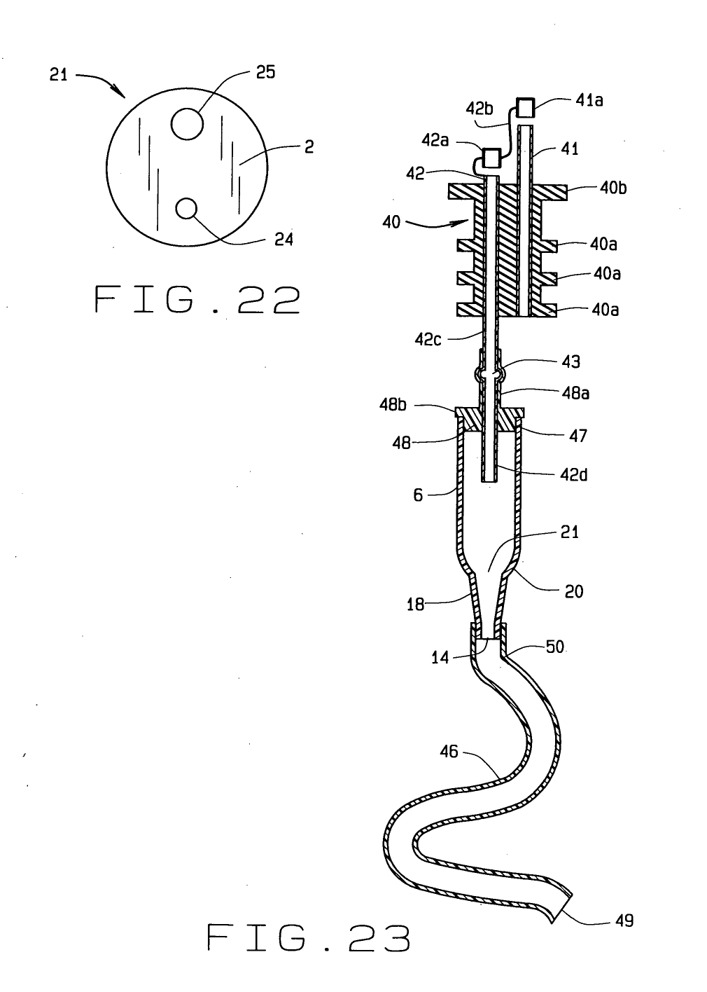

FIG. 23 then shows a section view of one embodiment of an embodiment of the present invention removed from a container B. The invention, shown in top view in FIG. 22, has a plug 40, generally round, to fit the neck N of a container. The plug is generally an elongated cylinder with at least three flanges 40a, generally mutually parallel and extending outwardly from the cylinder. The flanges have an outside diameter generally that of the inside diameter of the neck. Opposite the flanges and upon one end, the plug has its top 40b that has a diameter at least slightly more than the inside diameter of the neck. Preferably the top has a diameter that exceeds the outside diameter of the neck. The plug has two parallel lengthwise apertures that receive the liquid conduit 41, and the air conduit 42.

The liquid tube 41, which is in contact with the liquid aperture 25 has a cap 41a outwardly from the plug which a user can remove to begin the flow of liquid from within the container. The vent tube also has its cap 42a that fits upon the vent tube also outwardly from the plug. A user can remove the cap 42a from the vent tube to begin the flow of air into the container to eliminate the vacuum beyond the surface of the liquid therein. Preferably, the caps 41a, 42a have a common tether 42b secured to the plug that prevents inadvertent loss. The internal venting tube 42 has a generally elongated hollow cylindrical form. The internal venting tube 42, or air conduit, preferably extends from slightly above the top 40b of the plug, through the plug, and well below the plug as at 42c. Away from the plug, opposite the top, the vent tube, as at 42c, has a slight bulge outwardly as at 43. Preferably the bulge has a rounded outer surface and a diameter slightly more than the outside diameter of the vent tube. Beneath the bulge 43, the vent tube continues at its outside diameter and hollow construction, as at 42d.

The bulge 43 of the vent tube 42 receives a stem 48a of a reservoir plug 48. The stem 48a is a generally hollow, elongated cylinder with an inside diameter slightly larger than the outside diameter of the vent tube. The stem has sufficient length to slide over the bulge 43 in the vent tube 42 thus securing the reservoir plug 48 to the vent tube. The reservoir plug is generally cylindrical. In one embodiment, the reservoir plug has a flange 48b with a slightly larger diameter than the remainder of the reservoir plug. The reservoir plug has an aperture there through that admits the vent tube. The reservoir plug has a generally solid construction outside of the aperture to prevent migration of fluids and gases through, the reservoir plug. The stem 48a is generally an integral part of the reservoir plug 48 and centered thereon.

The reservoir plug 48 receives the reservoir 6 inwardly of the flange 48b. The reservoir is generally hollow and cylindrical in shape. The reservoir has an open superior end as at 47 and an opposite partially hemispherical inferior end as at 20. The inferior end has an aperture therein 21 that opens to a reservoir extension 18 that narrows to a tip as at 14. In this embodiment, a flexible air conduit or hollow tubing 46 extends from the reservoir 6 to the surface of liquid within a container B when the container is in the inverted position. The free end 49 of the tubing generally approximates the bottom of the container or follows the surface of the liquid when inverted while its opposite fixed end as at 50 fits upon the outside surface of the tip 14. The tubing may have buoyancy and sufficient length to exceed the height of the container B and to avoid kinking of the tubing. It may also approximate the air space of the container B while in the inverted position. Air is free to enter the container through the air aperture 24, which typically contains an air tube 42, into the reservoir and then into the reservoir extension, above the surface of the liquid remaining in the container B when inverted. The reservoir has sufficient volume to contain liquid from the reservoir extension when the container is inverted.

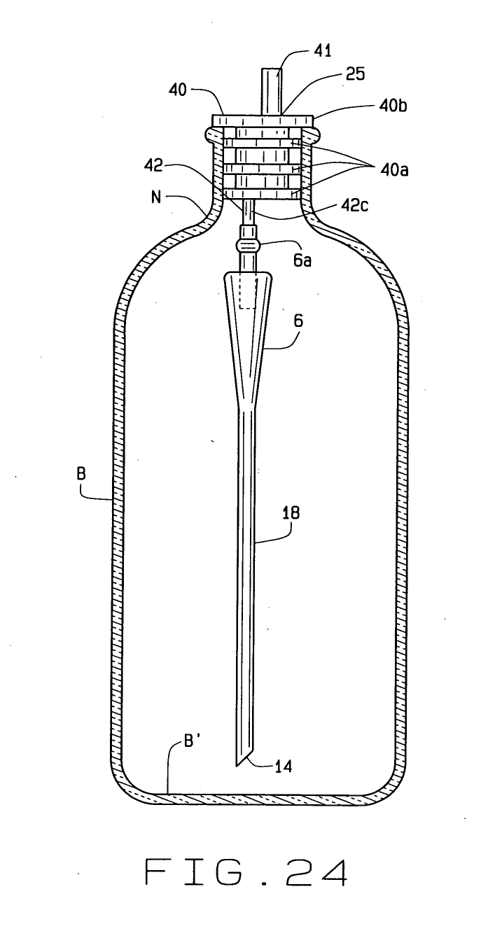

FIG. 24 shows a similar venting tube to FIG. 11, with the exception of a stopper or plug 40 utilized to seal the container B, rather than the cap like closure 5 seen in FIG. 11. FIG. 24 demonstrates an alternate embodiment of the invention where the container B has a generally narrow neck N. The neck has a plug 40 inserted within the narrow neck. The plug has its surface 2 as before that has an aperture 24 that vents air into the container and a nearby aperture 25 that passes fluid. This embodiment has a short section of tube utilized as an optional fluid conduit 41 placed through the fluid aperture 25. The liquid conduit is generally elongated and narrow as it extends from above the plug, though the plug, and preferably flush with the bottom of the plug. The air aperture 24 admits an internal venting tube 42 that extends from slightly above the surface, through the plug, and into the container. The internal venting tube 42 extends into the container as at 42c. This portion of the internal venting tube bulges outward slightly as described in FIG. 23. Over the bulges, the internal venting tube receives a grooved section, as at 6a, extending above the reservoir 6. The grooved section extends outwardly from the wide end of the reservoir as shown. Opposite the grooved section, the reservoir narrows in diameter to a reservoir extension 18. The reservoir extension typically has a length greater than the reservoir and a generally conical shape, but may be any shape, with a beveled opening proximate the bottom B′ of the container.

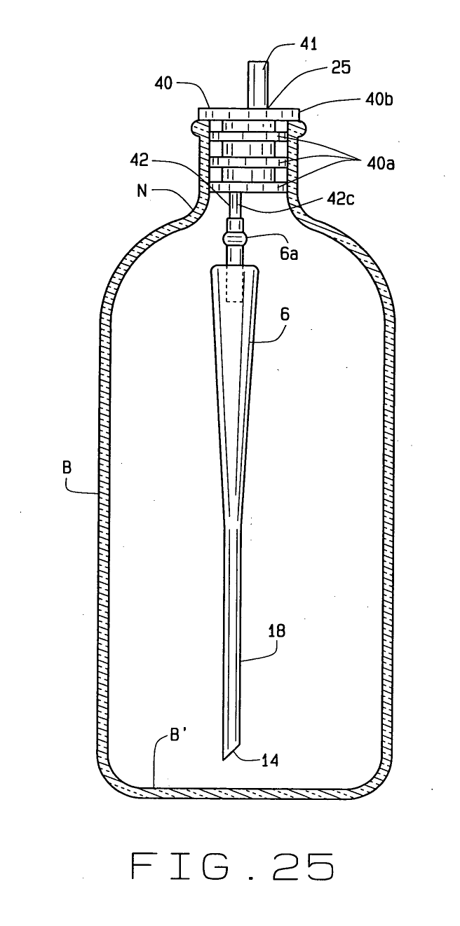

FIG. 25 shows similar construction and assembly of this alternate embodiment as in FIG. 24. However, the reservoir 6 has a greater length than in FIG. 24, and generally exceeds the length of the reservoir extension 18. The reservoir extends the preferably conical aspect of itself over a longer aspect of the vent of this embodiment.

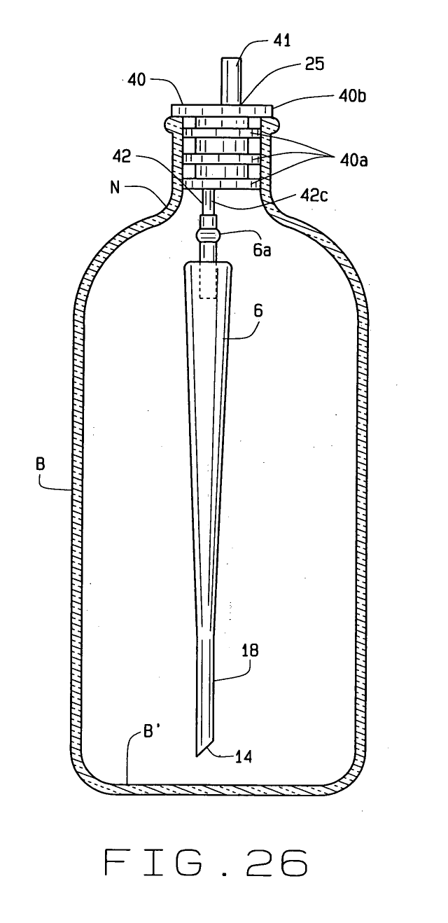

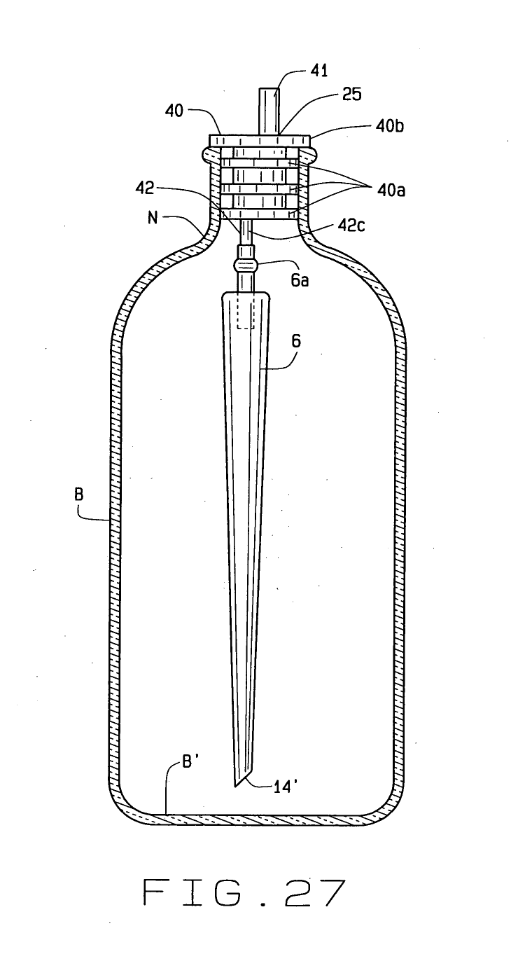

FIG. 26 shows similar construction and assembly as FIGS. 24 and 25, but the reservoir 6 again increases its length in proportion to the reservoir extension 18. The reservoir has a length of at least twice that of the reservoir extension. The reservoir retains its generally conical shape for its length, narrowing from a wide end proximate the internal venting tube to its merge with the reservoir extension. FIG. 27 then shows a reservoir 6 having a generally conical shape but without a reservoir extension as shown in FIGS. 24-26. The reservoir has a wide end proximate the internal venting tube 42c and the reservoir then tapers to its beveled opening as at 14.

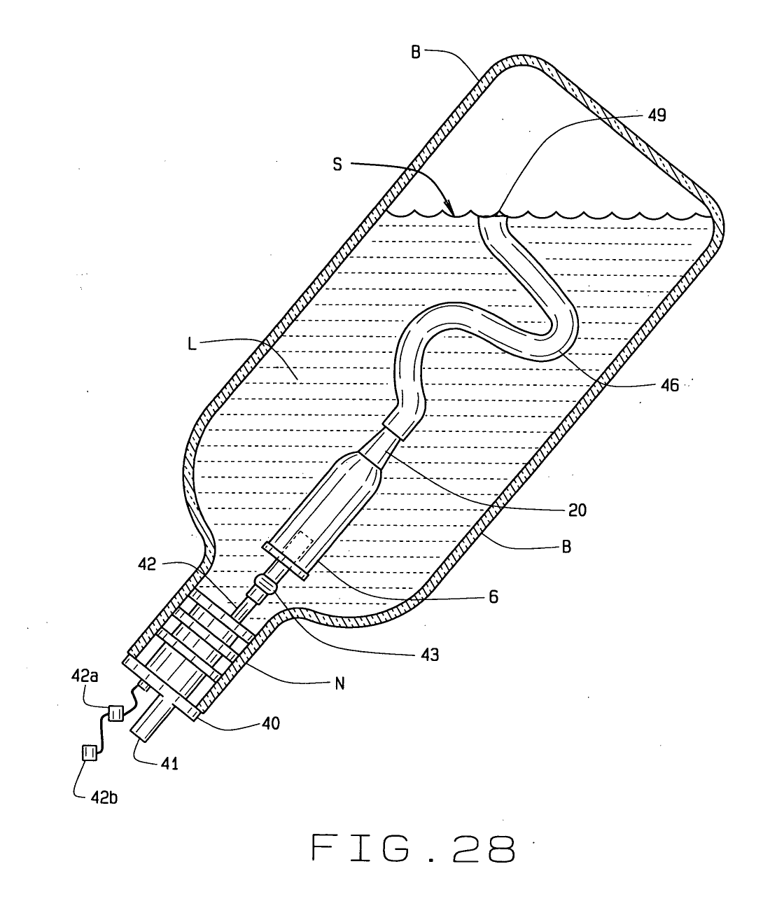

Building on the top view in FIG. 22, FIG. 28 shows an embodiment of the present invention employed in a container B to eliminate the blending of air in the liquid as shown in FIG. 2. This embodiment has its plug 40 installed in the neck N of an inverted container B. The container B has a quantity of liquid therein with a surface S locating away from the neck and towards the bottom of the container B. The plug has a pouring aperture and liquid conduit 41 extending through its length and into the neck. Generally parallel and near the liquid conduit 41, the venting aperture and air conduit 42 extends through the plug and into the vent. The internal vent tube, which is in contact with the venting aperture, bulges slightly, as at 43, for securement of a reservoir 6. The reservoir has a generally elongated cylindrical form rounded upon its inferior end as at 20. The inferior end of the reservoir provides a connection for a section of the preferably conical tubing 46. The tubing may have inherent buoyancy, that is, a density less than the liquid, may elongate, and then may float upon the surface S. The tubing opens at the surface, as at its free end 49, either through buoyancy or through its direction, and allows introduction of air above the surface but not through the liquid remaining in the container B.

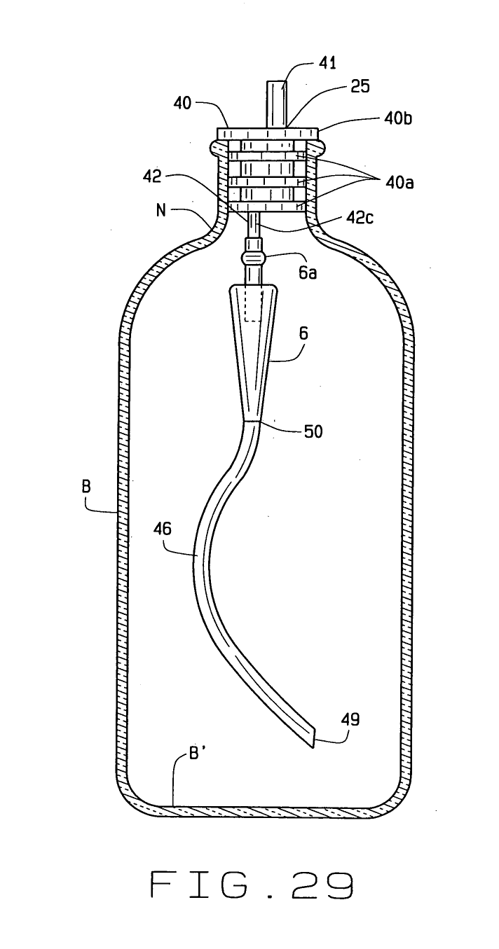

FIG. 29 demonstrates an alternate embodiment of the invention that has a venting mechanism as previously shown in FIG. 24. This venting mechanism has a preferably conically reservoir 6 with a grooved section 6a extending above the wide end of the reservoir towards the plug 40. The grooved section slips over the internal venting tube as at 6a. Opposite the grooved section, the reservoir tapers and connects at its distal aspect to the end 50 of a flexible vent extension 46, or tube. The free end 49 of the flexible reservoir extension can move within the container. The flexible vent extension typically has a length at least twice that of the reservoir as shown.

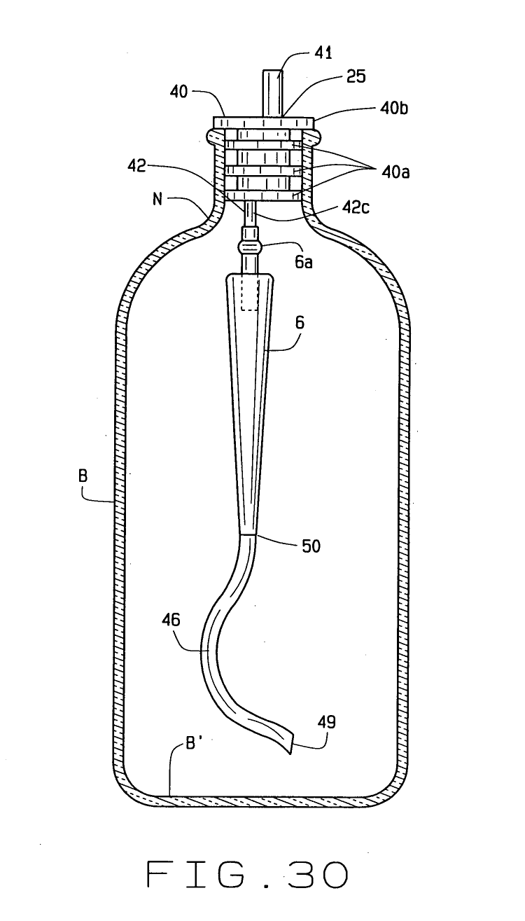

Slightly different than FIG. 29, FIG. 30 has a reservoir 6 in communication with the internal venting tube 42 through an enlarged section 6a. The reservoir, similar to FIG. 25, has a wide end from which the grooved section extends and a taper over its length. The reservoir in FIG. 30 has a greater length than in FIG. 29, approximately the same length as the flexible vent extension 46. As before, the end 50 connects to the narrow tip of the conical reservoir and the free end 49 moves within the container during usage, particularly inversion of the container.

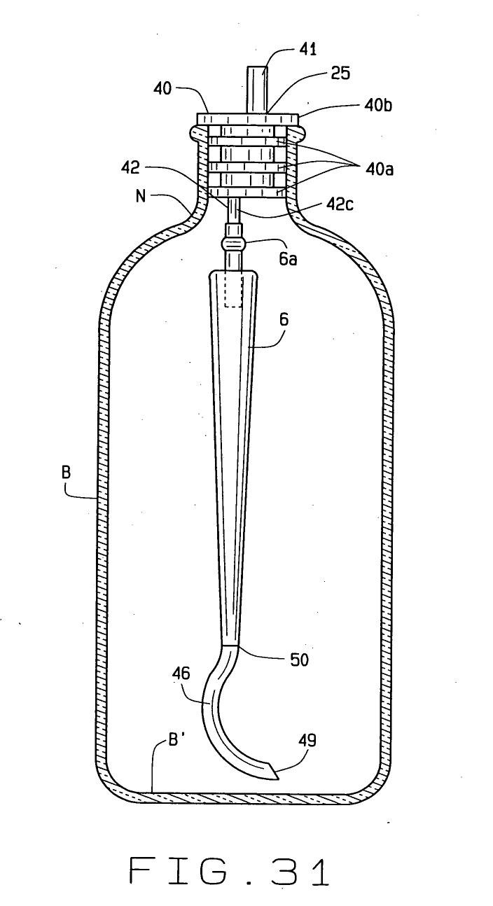

FIG. 31 also differs slightly from FIG. 30 by increasing the portion of the reservoir 6 of conical shape. The reservoir connects at its tip to the end 50 of the flexible vent extension 46. This reservoir has a length that greatly exceeds the length of the flexible vent extension as shown.

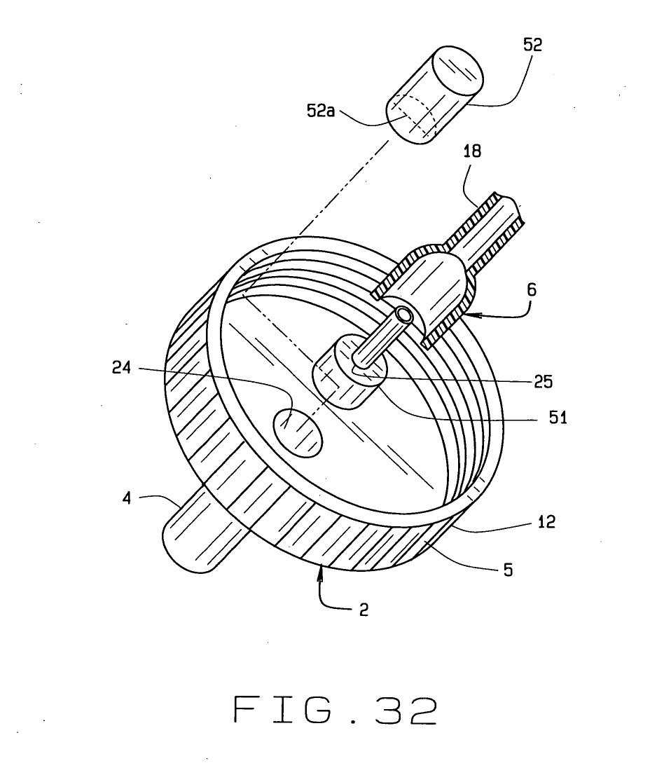

And, FIG. 32 provides a perspective view of the bottom of a closure 5 generally for a wide neck container though adaptable to a narrow neck bottle. The closure 5 has its surface 2 that has an aperture for passing liquids 24 and an aperture for venting air from a container as at 25. The liquid aperture 24 opens through a spout 4 integrally formed with the closure. The spout is generally a hollow tubular shape. The spout extends away from the surface 2 and opposite the perimeter flange 12. The spout opens flush at the surface within the flange 12. In this embodiment, the spout has an internal diameter of its round shape. The spout receives an optional check valve 52, generally of silicone, and a hollow cylinder. The check valve has two ends, one open and the other opposite end partially closed. The opposite end has two flaps separated by a slit 52a. The slit widens and the flaps move outwardly upon application of a partial vacuum by a user, such as a suckling infant. Without a partial vacuum, the slit closes the check valve which prevents liquid from passing through the spout. The liquid aperture 24 and hence the spout 4 are generally off center of the closure. Moving to the venting aperture 25, this aperture is generally centered upon the closure and extends beneath the surface 2 as an optional raised boss 51. The raised boss has a round cylindrical shape with a thickness less than its diameter. The raised boss forms integrally with the closure. The diameter of the raised boss provides for a press fit connection of a reservoir 6. The reservoir has its length and then narrows to a reservoir extension 18 as previously described. The venting aperture 25 extends through the surface and the thickness of the raised boss.

In operation, one connects reservoir 6 to the closure or associated components or aspects, if it is not already present. The reservoir extension is preferably above the level of the liquid in the container B when the container is inverted to empty the liquid from the container.

This ensures continuous and full venting of the container without aeration and contamination of the liquid in the container. It also ensures the presence of a positive pressure in the container, so that the liquid may be withdrawn from the container on demand, without the interference of vacuum, which is present in traditional containers, other than those of the current inventors. Leakage is also prevented due to the diameters of the pouring aperture, or liquid aperture, 25 and the venting aperture, or air aperture 24. One range of proportions of internal diameters of the pouring aperture to the venting tube is approximately 2.5:1 (liquid aperture: venting tube internal diameter) and allows for rapid and simultaneous reentry of the liquid inside the venting tube into the container B followed by air entry above the level of liquid when the container is inverted. Optional flanges as at 9, 10 are shown. Optional flange 9, the stop flange, is external to the diameter of the venting tube and maintains the position of the venting tube and reservoir 6. Optional flange 10, the retainer flange, is internal to the venting tube and retains any fluid in the venting tube or reservoir 6 while the container is in use.

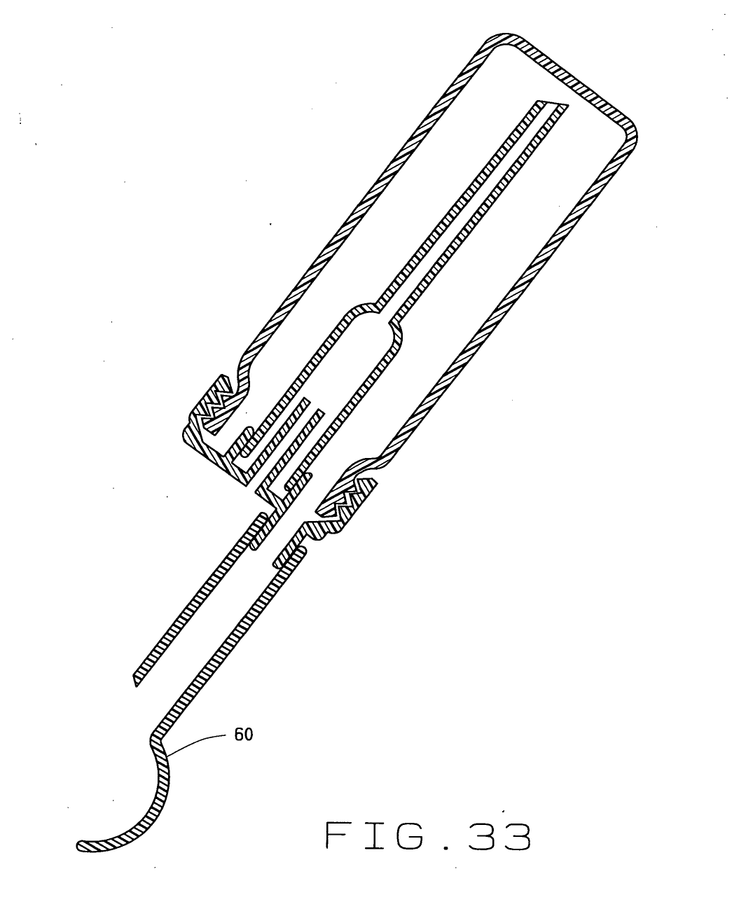

FIGS. 3 and 4 are the preferred embodiment of the infant feeding version of the invention. The internal venting tube provides an air conduit while keeping the liquid and the air flows separate during usage as the reservoir retains any liquid that moves proximally into the venting tube. The container may contain any type of desired substance and the substance may be dispensed using any type of dispensing device. Some common dispensing devices are nipples in infant feeding bottles and spouts for containers with sports liquids. Any liquid conduit or simply an aperture is frequently used with liquor containers. Any type of dispensing device may be used. Also, the liquid aperture may dispense a solid or liquid substance onto a surface where any amount may accumulate and subsequently be presented at any time and at any desired rate. An example of this type of dispensing is allowing formula or any other liquid to drop onto a spoon shaped device 60 to a certain amount and then feeding an infant with a desired amount of the liquid at a certain rate, as in FIG. 33. Alternatively, an aperture in the container or closure or other portion of the substance containing device may be utilized. In all embodiments, all portions of both the air and liquid apertures and their associated components may be integral to various portions of the container or its associated parts, or come in any combination separately or attached. All portions of the apertures and their associated parts may be of any size or configuration that fulfills the requirements of the inventions.

Variations or modifications to the subject matter of this disclosure may occur to those skilled in the art upon reviewing the summary as provided herein, in addition to the description of its preferred embodiments. Such variations or modifications, if within the spirit of this development, are intended to be encompassed within the scope of the invention as described herein. The description of the preferred embodiment, as well as all embodiments, as provided, and as shown in the drawings, is set forth for illustrative purposes only. From the aforementioned description, a container venting mechanism has been described. Thus, for the first time, as demonstrated in all versions of the current invention and without utilizing a horizontal air conduit, this vent mechanism is uniquely capable of continuous and full venting, without leaking, and without aerating and contaminating the liquid in the container, while providing a positive pressure in the container, so that liquid may be removed on demand without the interference of vacuum, as seen in traditional containers. This vent mechanism and its various components may be manufactured from many materials, including, but not limited to singly or in combination, polymers, polyester, polyethylene, polypropylene, polyvinyl chloride, nylon, ferrous and non-ferrous metals and their alloys, and composites.

We claim:

1. A vent preventing formation of a vacuum within an inverted container having liquid within and preventing leakage of liquid, said vent comprising:
a venting means, having a superior aspect and an opposite inferior aspect, with the superior aspect locating in any portion of the container, said venting means having a proximal first end and an opposite second end projecting sufficiently downwardly into the container so that: upon inversion of the container said second end extends above the liquid therein;
an aperture upon said first end an aperture upon said second end
an air conduit extending into said venting means, said air conduit having a proximal end and a distal end wherein said proximal end and said distal end are open;
an airway in said venting means extending from the outside of the container through said proximal end aperture to said distal end aperture of said venting means; and
a liquid aperture outwardly of the said proximal end aperture, said liquid aperture in communication with liquid within the container when inverted wherein said liquid may be dispensed.

2. A vent according to claim 1 further comprising:
a closure adapted for the container; and,
said air conduit conducting air from outside the container to a conical venting tube locating with the container.

3. The vent according to claim 2 further comprising:
said venting means including a plug, said plug having said proximal and said distal apertures, and said plug attaching said air conduit to said venting tube.

4. A vent preventing formation of a vacuum within an inverted container having liquid within and preventing leakage of liquid, said vent comprising:
a venting means, with the superior aspect residing in any aspect of the container, said vent having a proximal first end and an opposite second end projecting sufficiently downwardly into the container so that upon inversion of the container said second end extends above the liquid therein;
a closure of said container;
an airway in the venting tube extending from the outside of said container or said closure, to the distal end of said venting tube; and
an aperture in communication with liquid within the container when inverted wherein said liquid may be dispensed.

5. A vent preventing formation of a vacuum within an inverted container having liquid therein, said vent comprising:
a reservoir and a reservoir extension, said reservoir having a proximal first end and said extension having an opposite second end projecting sufficiently downwardly into the container so that upon inversion of the container said second end extends above the liquid therein;
a plug fitting superiorly upon said first end;
an air conduit extending into said reservoir and having a proximal end and an opposite distal end, said proximal end and said distal end being open such that said distal end is positioned in the volumetric center of said reservoir and such that double venting is utilized;
an airway in the reservoir extending from the outside of the container through said plug to a point in the reservoir above the liquid in the reservoir when the container is inverted; and,
a liquid aperture in communication with liquid within the container when inverted;
wherein said vent utilizes double venting to prevent fluid discharge from said reservoir and the container when inverted.

6. The vent according to claim 5 further comprising:
a closure of the container; and,
said air conduit extending inferiorly from said closure or said container and communicating into said airway, said air conduit having a distal end projecting into said reservoir wherein the distal end of said air conduit exceeds the liquid remaining in said reservoir when said container is inverted.

7. The vent according to claim 6 further comprising:
said closure or said container attaching said air conduit to said reservoir; and,
said reservoir extension projecting to an inferior aspect of said container.

8. The vent according to claim 7 wherein said vent is detachable from said container.

9. The vent according to claim 8 wherein said reservoir has a larger diameter than said reservoir extension.

10. A container venting its interior to the atmosphere and resisting formation of a vacuum when the container is inverted to dispense a liquid therefrom, the container comprising:
a container adapted to hold liquid and a closure for said container;
a liquid outlet for dispensing the liquid when said container is inverted;
a linear vent adapted to said container;
said vent comprising a reservoir and a venting means, such as an extension, said reservoir having a proximal first end adjacent to the aperture of said closure and the extension having an open second end projecting downwardly into said container so that upon inverting said container, said open second end is above the level of the liquid in said container; and,
an air conduit through said vent extending between the outside of said container and said reservoir above the level of any liquid remaining in said reservoir upon inversion of said container.

11. An improved vent for a container of liquid, the improvement comprising:
a generally linear venting means having a proximal open first end and an open second end, said second end projecting distally into said container so that when said container is inverted, said second end being above the level of the liquid in the inverted container; and,
an air conduit between the outside of the container and a point in said linear vent above the level of any liquid trapped inside said linear vent when the container is inverted, the air passage and said linear vent allowing atmospheric air to flow into the container to prevent the formation of a vacuum within the container when liquid is withdrawn.

12. An improved vent as set forth in claim 11 further comprising:
said linear vent venting through its length;
a closure of said container;
a reservoir and an extension having an open proximal end and an open distal end, said proximal end being proximate to said closure, said distal end projecting downwardly into said container so that upon inversion of said container said distal end is above the liquid in said container, said reservoir having an air conduit on its superior aspect and the superior aspect of said air conduit is exposed to atmospheric pressure;
wherein any liquid in the reservoir remains below the inferior aspect of the air conduit in any position.

13. A container adapted to be filled with liquid and having a vent unit that prevents formation of a vacuum within said container when inverted, said vent unit comprising:
a reservoir and a venting means extension, said extension being along the longitudinal axis of said container and venting there through; and,
an air conduit forming a portion of an airway, said air conduit having a distal end projecting downwardly into said reservoir above the level of liquid trapped in the reservoir upon inversion of said container.

14. A vent, wherein the vent prevents a vacuum from being formed within a container when inverted, the vent comprising:
a closure having a fluid aperture and an air aperture or alternatively said fluid and air apertures residing on said container;
a vent unit adapted to fit within the container comprising a reservoir and its venting means extension having an upper and lower portion, the reservoir and extension having a proximal first end adapted to fit adjacent said air aperture and an open second end projecting sufficiently downwardly in the container so that when the container is inverted the open second end is above the level of the liquid in the container;
an airway in the vent unit extending between the outside of the container and a point in the reservoir above the level of the liquid trapped in the reservoir when the container is inverted;
wherein said vent utilizes double venting to prevent fluid discharge from said reservoir and the container when inverted.

15. A vent, wherein the vent prevents a vacuum from being formed within a container when inverted, the vent comprising:
an air conduit extending from the closure of the container, the container, or the dispenser to the inferior aspect of the container;
said air conduit vents outside air to the inside of the container equalizing the external flow of liquid from the container;
said air conduit returns any liquid therein into the container; and,
a liquid conduit generally spaced away from said air conduit, said liquid conduit allowing uninterrupted egress of liquid from said container when inverted.

16. The vent according to claim 15 further comprising:
said air conduit enlarged at its proximal aspect; and
said air conduit attachable to one of said closure or said container; and
said closure containing an air conduit internal to said enlargement of said air conduit approximating the interior of said enlargement of said air conduit, such that double venting occurs.

17. The vent according to claims 16 further comprising:
said air conduit including buoyant tubing having a free end that seeks the level of liquid in said container when inverted therein allowing passage of air from said reservoir above said liquid without the air mixing into said liquid.

18. The vent according to claim 1 further comprising:
an attachment to said container permitting various methods of utilizing the contents of said container.
